(19) United States
(12) Patent Application Publication
(10) Pub. No.: US 2019/0057449 A1
(43) Pub. Date: Feb. 21, 2019

(54) SYSTEM AND METHOD FOR FINANCIAL PLANNING, ADVICE AND MANAGEMENT

(71) Applicants: Arthur M. Berd, New York, NY (US); Rohit M. D'Souza, New York, NY (US); Anton B. Fokin, St. Petersburg (RU)

(72) Inventors: Arthur M. Berd, New York, NY (US); Rohit M. D'Souza, New York, NY (US); Anton B. Fokin, St. Petersburg (RU)

(73) Assignee: Wealth Technologies Inc., New York, NY (US)

(21) Appl. No.: 15/960,637

(22) Filed: Apr. 24, 2018

Related U.S. Application Data
(60) Provisional application No. 62/547,786, filed on Aug. 19, 2017.

(51) Int. Cl. G06Q 40/06; G06Q 40/04

(52) U.S. Cl. CPC G06Q 40/06; G06Q 40/04

(57) ABSTRACT

A financial planning system automatically chooses which goals to fund, and which assets to liquidate to enable goal funding. A user specifies her goals with associated priorities, possibly with a variable timeframe and/or a variable cost. As the system decides that a goal is affordable, by determining that the user's wealth in a simulation scenario exceeds a benchmark based on the user's financial situation, the system changes that goal to a committed life action. The user's investment allocation may automatically change in response to one or more of the user's age, life actions and total wealth. If the simulation scenarios result in an acceptable plan, and if the user has given permission, the financial planning system then acts on this plan, such as by moving funds among accounts or placing securities trades. The system can be used for asset management, money management, and consumption advice.

### CROSS-REFERENCE TO RELATED APPLICATIONS

This application claims priority to U.S. provisional patent application Ser. No. 62/547,786, filed Aug. 19, 2017, having common inventors herewith, and a common assignee herewith, the disclosure of which is hereby incorporated by reference.

### BACKGROUND OF THE INVENTION

The present invention relates to a financial planning system that affects client accounts at third-party entities via software operating automatically.

A financial planner advises his or her client as to how to invest to achieve their financial goals. Computer-based systems exist that automate the calculations and projections typically made by a financial planner.

FIG. 1 shows configurations for a conventional financial planning (CFP) system.

A solo financial planner may execute software on their personal computer 50, and may use Internet 10 to access client accounts at banks 20 or brokerages 30. The financial planner may use information service 40 to obtain, e.g., quotes for current market valuation of client investments.

Alternatively, a solo financial planner having personal computer 50, with locally stored client information 55, can use a CFP system operative at financial planning server 60. Instead of a personal computer, the financial planner can use a tablet computer or a smartphone. Typically, personal computer 50 uses a public network, such as Internet 10, to communicate with server 60. In one configuration, referred to as software-as-a-service (SaaS), personal computer 50 has an operating system and browser, but lacks special software. In another configuration, referred to as a client-server configuration, personal computer 50 must first download special client software, and must execute this client software to gain access to the program at financial planning server 60.

An employee financial planner typically uses personal computer 70 on the premises of their employer, which operates financial planning server 60. Local area network (LAN) 62 provides the physical connection from personal computer 70 to financial planning server 60. The client information is stored in storage device 75 that is connected to LAN 62. Financial planning server 60 may use the Internet to access client accounts at banks or brokerages.

Alternatively, an employee financial planner can use financial planning server 60 in a SaaS or client-server configuration.

CFP software can be characterized as goal-based (CFP-GB), cash-flow-based (CFP-CF), or hybrid (CFP-HY).

In a goal-based system, the CFP-GB system explicitly allocates certain funds towards achieving a particular goal and then projects whether the goal can be achieved under simulations. Goals are funded separately, and the likelihood of their achievement is evaluated based on a Monte Carlo analysis of investments dedicated towards each goal. In a purely goal based system, there is no accounting of incomes and expenses, but instead there is an assumption about a level of necessary savings needed to achieve the set goals. The household's actual cash flows remain to be determined by the advisor in a separate exercise to see if the savings can be achieved.

The outcome of the CFP-GB system is a goal-based financial plan (FP-GB), which outlines how much ongoing savings in total are required in order to achieve the customer's goals and how these savings should be apportioned across the goals, and what allocation of investment products is recommended for investing these savings towards the goals.

FIG. 2A is a graph showing a single goal CFP-GB account. Assume that the goal involves one-time spending of a fixed amount, such as a piece of jewelry. Curve A shows the savings per period that the client expects to add to the goal account. Curve B shows the cumulative investment return on the savings in the account. Curve C shows that all of the money in the account is spent on the goal. Curve D shows the balance in the account: savings+return on investment−spending.

FIG. 2B is a graph showing three accounts for three goals in a CFP-GB system, such as home purchase, college tuition for one child, retirement nest egg, and boat. Each account behaves as in FIG. 2A. Importantly, the accounts are maintained independently.

During system set-up (not shown), the financial planning system is configured with tax tables, so that a client's estimated taxes can be automatically computed, and with expected life tables, so that years of retirement can be estimated.

FIG. 2C is a flowchart showing client set-up in a CFP-GB system.

At step 105, the user, either a financial planner acting on behalf of his/her client, or the client him/herself, opens an account for the client, and populates it with the client's age. The system then looks up the client's expected life, subtracts the user's age, and determines the timeframe T for the financial plan, in months, from the present month until the client's expected end of life. The user provides an initial savings balance (ISB) for the client, an expected monthly savings amount for each month, and a set of goal amounts G$[g], g=1 . . . G, and corresponding goal end dates GT[g].

At step 110, the user identifies the client's accounts with third-party systems, such as banks or brokerages, and provides access (read) and/or alteration permission. Most brokerages are set-up to enable a financial advisor to trade a client's account, but not withdraw funds therefrom.

At step 115, the financial planning system populates the client's account with information from the client's third-party accounts.

At step 120, the financial planning system gets initial values for the market environment for the client's account. Typically, this includes current prices for the financial instruments that the users holds, and might wish to hold, and price history for these financial instruments, to derive volatility per instrument. The market environment may also include future forecasts for returns and risk, if the planning system relies on such forecasts.

FIG. 2D is a flowchart showing operation in a CFP-GB system.

At step 150, the financial planner identifies the investments INV v=1 . . . V that will be used in the financial plan, and their risk parameters. For example, the investments that will be considered may be INV={bond1, bond2, bond3, equity1, equity2, equity3}, where each investment is a mutual fund or exchange-traded fund. Assume that bond1 and equity1 have low risk, bond2 and equity2 have medium risk, and bond3 and equity3 have high risk.

At step 155, the financial planning system pre-computes a set of Monte Carlo simulations, to create a Scenario Investment Return array SIR[n,t,v] based on the number of scenarios n=1 . . . N, where N is typically chosen as a large number such as 1,000; the time periods t=1 . . . T, where T was computed at step 105 of FIG. 2C; and the investments v=1 . . . . V chosen at step 150.

The Monte Carlo simulations use random numbers to simulate the behavior of markets. For instance, a low risk investment may be defined to have a monthly return in the range −10% to +10%, a medium risk investment may be defined to have a monthly return in the range −20% to +20%, a high risk investment may be defined to have a monthly return in the range −30% to +30%. The probability distribution for each investment may be defined as Gaussian (bell-shaped), centered at 2% for low risk investments, 6% for medium risk investments, and 12% for high risk investments. For each time period, a pseudo-random number in the range 0 to 1 is generated, with the distribution being equiprobable. Then, the generated number is mapped into a range using the probability distribution appropriate for the type of investment. Other techniques may be used to generate the Scenario Investment Return array SIR[n,t,v], such as a Monte Carlo simulation.

At step 160, the financial planner creates the Goal Accounts, one per goal.

At step 165, the financial planner sets the starting conditions, also referred to as a Trial Financial Plan, by allocating the ISB among the Goal Accounts, setting weights ws[g] for allocating monthly savings S (from step 105 of FIG. 2C) among the Goal Accounts, selecting k=1 . . . K investments for each goal account, and setting the weights w[g,k] for the investments in the Goal Accounts. Table 1 below shows an exemplary Trial Financial Plan, assuming ISB=$100,000.

TABLE 1

| | | college | | |
|---|---|---|---|---|
| | | tuition | | |
| | home | for one | retirement | |
| Goal | purchase | child | nest egg | boat |
| ISB allocation for | $50,000 | $5,000 | $40,000 | $5,000 |
| goal account | | | | |
| ws[g] | .50 | .15 | .30 | .05 |
| weights for savings | | | | |
| S allocation | | | | |
| investments | equity2 | bond1 | equity2 | equity1 |
| | equity3 | bond2 | bond2 | equity2 |
| | bond1 | bond3 | bond3 | equity3 |
| wI[g, k] | .30 | .20 | .40 | .20 |
| | .10 | .30 | .30 | .20 |
| | .60 | .50 | .30 | .60 |

At step 170, the financial planning system creates the N scenarios based on the Trial Financial Plan and the Scenario Investment Return SIR[n,t,v] from the Monte Carlo simulation. For each scenario, for each time period, for each goal account, the financial planning system system computes the Goal Account Return GAR[n,t,g]:

GAR[n,t,g]=Σₖ₌₁^{K}SIR[n,t,k]*wI[g,k] (equation 1)

and computes the Goal Account balance GA[n,t,g]:

GA[n,t,g]=(1+GAR[n,t,g])*GA[n,t−1,g]+S[t,g] (equation 2)

The financial planning system rebalances the goal account investments to conform to the weighted allocation in the Trial Financial Plan. If the goal's time limit GT[g] has been reached, the financial planning system closes the goal account for the goal, stores the final value of the Goal Account GAFV[n,g]=GA[n,t=GT[g],g], and allocates the savings that would have been used for the goal to other goals by a suitable method such as proportional reallocation or weighted reallocation. In proportional reallocation, each adjusted savings weight ws_adj[g] is increased by the same amount. Assume goal1 (g=1) has been reached, then for g=2 . . . G

ws_adj[g]=ws[g]+ws[1]/(g−1) (equation 3)

In weighted reallocation, each adjusted savings weight ws_adj[g], g=2 . . . G, is increased so that its share of savings remains constant:

ws_adj[g]=ws[g]+ws[g]/Σ_{g=2}^{G}ws[g] (equation 4)

At step 175, the financial planning system determines the goals success likelihood across all scenarios based on the stored GAFV[n,g]. A goal has succeeded when the scenario-wide GAFV[n,g] is at least equal to the goal amount G$[g] specified at step 105 of FIG. 2C. The Heaviside step function 1(·) has a value of one for positive arguments and zero for negative arguments.

Goals_success_likelihood=N⁻¹*Σₙ₌₁^{N}1(GAFV[n,g]≥G$[g]) (equation 5)

At step 180, the financial planning system decides whether the Trial Financial Plan is acceptable, that is, whether equation 4 is true for all goals g=1 . . . G. If so, processing continues at step 185. If not, processing returns to step 165, and the financial planner adjusts the Trial Financial Plan.

At step 185, the financial planning system defines the recommended financial plan as the first Trial Financial Plan that was deemed acceptable at step 180.

At step 190, if the customer has given permission, the financial planning system automatically moves funds among accounts, and/or places trades. Fund movement occurs when the ISB is allocated among accounts, when the monthly savings is allocated among accounts, and when accounts are rebalanced to conform to the financial plan.

In a cash-flow-based system, the CFP-CF system is acting more like an accounting system that projects into the future. It computes the planned incomes, expenses, accounts for taxes and other withholdings, and projects a simulated investment portfolio income. The goals in CFP-CF system are also represented as specific cash flow outlays planned for specific times in the future, such as a plan to purchase a second home 5 years from now or a plan to pay for kids' college expenses when they reach 18 years old. The system projects the cash flows and alerts the advisor if there is a deficit or surplus in cash flows under the advisor's financial plan assumptions.

The outcome of the CFP-CF system is a cash-flow-based financial plan (FP-CF), which outlines the parameters of the goals that are achievable given the customer's income and expenses assumptions, as well as the allocation of net savings across investment accounts and across investment products within accounts, recommended in order to achieve the selected goals.

FIG. 3A is a graph separately showing three goals in a CFP-CF system. Curve A shows the calculated savings per period that the client expects to add to the goal account, where savings=income−expenses−taxes. Curve B shows a first goal, with spending over a short time, such as college tuition for one child. Curve C shows a second goal, with one-time spending, such as a jewelry purchase. Curve D shows a third goal with spending over an extended period, such as retirement.

FIG. 3B is a graph showing events in a CFP-CF system. Curves A-D are as above. Curve E shows the cumulative investment return on the savings in the account, note that ater money is spent on a goal, the account balance is reduced so the investment return is calculated on a reduced amount, and thus is smaller. Curve F shows the balance in the account: savings+return on investment−spending.

FIG. 3C is a flowchart showing client set-up in a CFP-CF system.

Step 205 is similar to step 105 of FIG. 2C, except that instead of providing monthly savings S[t], the user provides monthly income INC[t] and monthly expenses EXP[t].

Steps 210, 215 and 220 are similar to steps 110, 115 and 120 of FIG. 2C.

FIG. 3D is a flowchart showing operation in a CFP-CF system.

Steps 250 and 255 are similar to steps 150 and 155 of FIG. 2D.

At step 260, the financial planner selects k=1 . . . K investments for the client's single account, and sets weights w[k] for the investments in the single portfolio account. All goals are funded from this single account. The selected investments k=1 . . . K, and the weights w[k] comprise the Trial Financial Plan.

At step 270, the financial planner set the initial account balance B[t=0] to be the ISB.

At step 275, the financial planning system creates the N scenarios based on the Trial Financial Plan and the Scenario Investment Return SIR[n,t,v] from the Monte Carlo simulation. For each scenario, for each time period, for the single portfolio account, the financial planning system system computes the Net Savings NS[t], where GCF[t,g] represents the goal cash flow spending for goal g at time t:

NS[t]=INC[t]−EXP[t]−TAXES[t]−Σ_{g=1}^{G}GCF[t,g] (equation 6)

then computes the scenario's Portfolio Return PR[n,t]:

PR[n,t]=Σₖ₌₁^{K}SIR[n,t,k]*wI[k] (equation 7)

then computes the account balance B[n,t]

B[n,t]=(1+PR[n,t])*B[n,t−1]+NS[t] (equation 8)

The financial planning system rebalances the goal account investments to conform to the weighted allocation in the Trial Financial Plan, as at step 170 of FIG. 2D. Rebalancing is needed because market growth, regardless of the financial plan, may be different for different investments, causing the portfolio to become imbalanced relative to the desired balance. At the conclusion of the scenario, the financial planning system stores the account balance B[n,t=T].

At step 280, the financial planning system determines the goals success likelihood across all scenarios based on the stored B[n,T]. If B[n,T] is positive, then the scenario is a success.

Goals_success_likelihood=N⁻¹*Σₙ₌₁^{N}1(B[n,T]>0) (equation 9)

At step 285, the financial planning system decides whether the Trial Financial Plan is acceptable, that is, whether the Success_metric is greater than 0. If so, processing continues at step 290. If not, processing returns to step 260, and the financial planner adjusts the Trial Financial Plan.

At step 290, the financial planning system defines the recommended financial plan as the first Trial Financial Plan that was deemed acceptable at step 285.

At step 295, if the customer has given permission, the financial planning system automatically moves funds among accounts, and/or places trades. Fund movement occurs when the ISB is allocated among accounts, when the monthly savings is allocated among accounts, and when accounts are rebalanced to conform to the financial plan.

In a hybrid system, the CFP-HY system is based on goals, like in case of CFP-GB system, however instead of relying on assumption about the level of net savings, it uses a more detailed accounting for cash flows, like in case of CFP-CF system. In a CFP-HY system, all goals are funded together, from the overall net cash flows.

The outcome of the CFP-HY system is a hybrid financial plan (FP-HY), which outlines the recommended levels of net savings (i.e. recommended level of expenses given the customer's income assumptions) together with the parameters of the goals that are achievable given such level of savings, as well as the allocation of net savings across investment accounts and across investment products within accounts, recommended in order to achieve the selected goals.

FIG. 4A is a graph showing a single goal CFP-HY account. Curves A-D of FIG. 4A are similar to curves A-D of FIG. 2A, except that in FIG. 4A, curve A is computed rather than being provided directly by the client or a financial planner, and curve C show a goal that involves spending for a short time, such as college tuition, rather than a one-time spending spike.

FIG. 4B is a graph showing three accounts for three goals in a CFP-HY system. As in a CFP-GB system, each goal has a separately funded goal account. As in a CFP-CF system, the savings allocation for each goal is based on the client's income, expenses and taxes. When a goal's spending has ended, the savings allocation is split among the remaining goal accounts according to a suitable re-allocation method, as discussed above for a CFP-GB system.

FIG. 4C is a flowchart showing client set-up in a CFP-HY system. CFP-HY client set-up steps 305, 310, 315, 320 are similar to CFP-CF setup steps 205, 210, 215, 220, discussed above.

FIG. 4D is a flowchart showing operation in a CFP-HY system.

Steps 350, 355, 360, 365 are similar to steps 150, 155, 160, 165 of FIG. 2D.

Step 370 is similar to step 170 of FIG. 2D, except that at the start of step 370, the net savings is calculated as at step 275, equation 6, of FIG. 3D. Then, the net savings is allocated among goal accounts:

S[t,g]=ws[g]*NS[t] (equation 10)

Steps 375, 380, 385, 380 are similar to steps 175, 180, 185, 190 of FIG. 2D.

However, there is room for improvement in financial planning systems.

### SUMMARY OF THE INVENTION

In accordance with an aspect of this invention, there are provided a method of and a system for financial planning for a user comprising receiving, from the user: life actions, goals, an investment strategy, and an acceptability threshold; generating a benchmark based on the life actions and the goals; determining wealth based on the investment strategy and the life actions; converting goals to life actions when the determined wealth exceeds the benchmark; and deciding a financial strategy is acceptable when goal success likelihood exceeds the acceptability threshold, the goal success likelihood being the probability that the respective goals were converted to life actions; wherein the financial strategy comprises the life actions, the goals, the investment strategy, the acceptability threshold and the benchmark.

It is not intended that the invention be summarized here in its entirety. Rather, further features, aspects and advantages of the invention are set forth in or are apparent from the following description and drawings.

### BRIEF DESCRIPTION OF THE DRAWINGS

FIG. 1 shows configurations for a conventional financial planning (CFP) system;

FIG. 2A is a graph showing a single goal CFP-GB account;

FIG. 2B is a graph showing three accounts for three goals in a CFP-GB system;

FIG. 2C is a flowchart showing client set-up in a CFP-GB system;

FIG. 2D is a flowchart showing operation in a CFP-GB system;

FIG. 3A is a graph separately showing three goals in a CFP-CF system;

FIG. 3B is a graph showing events in a CFP-CF system.

FIG. 3C is a flowchart showing client set-up in a CFP-CF system;

FIG. 3D is a flowchart showing operation in a CFP-CF system;

FIG. 4A is a graph showing a single goal CFP-HY account;

FIG. 4B is a graph showing three accounts for three goals in a CFP-HY system;

FIG. 4C is a flowchart showing client set-up in a CFP-HY system;

FIG. 4D is a flowchart showing operation in a CFP-HY system;

FIG. 5 shows configurations for a financial planning system according to the present invention;

FIG. 6 is a chart showing prioritized goals with time and cost variability;

FIG. 7 shows a goal with value variability;

FIG. 8A-8H are graphs showing generation of MWAG curves;

FIG. 9 is a flowchart showing system set-up in a financial planning system according to the present invention;

FIG. 10 is a flowchart showing client registration in a financial planning system according to the present invention;

FIGS. 11A-11C are a flowchart showing operation in a financial planning system according to the present invention; and

FIG. 12 is a graph showing Monte Carlo simulations of a user's financial life compared to MWAG curves.

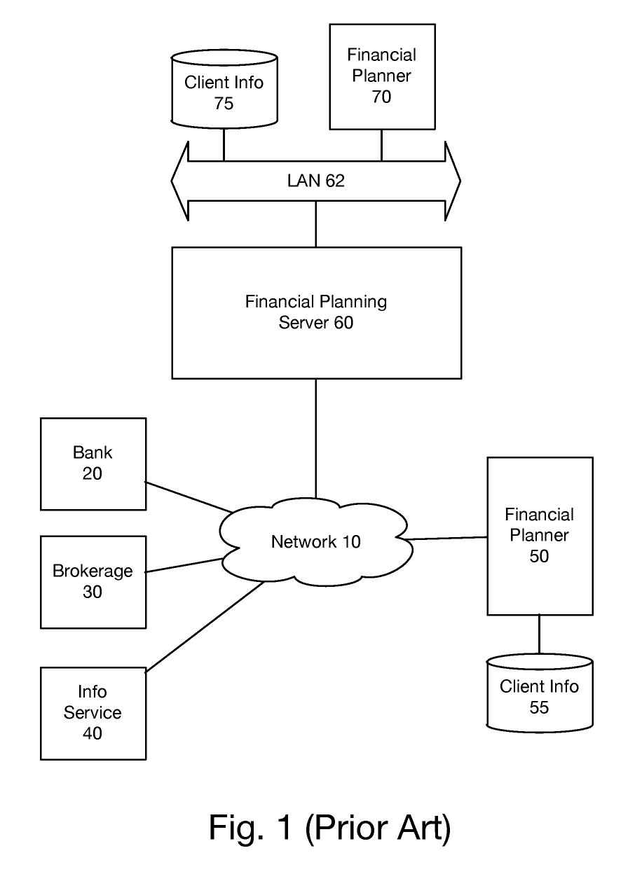

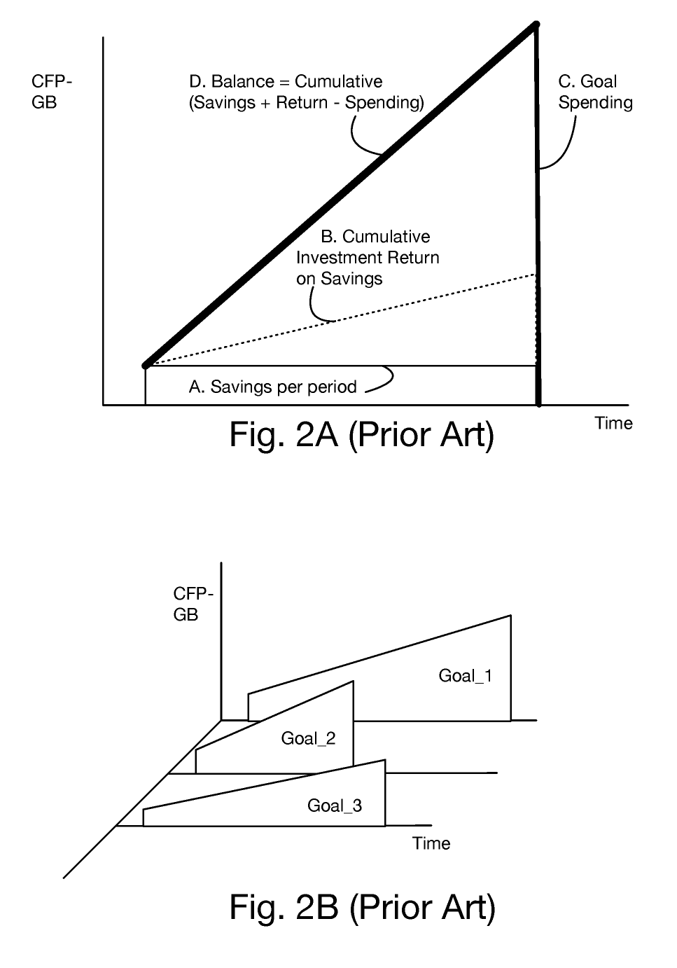

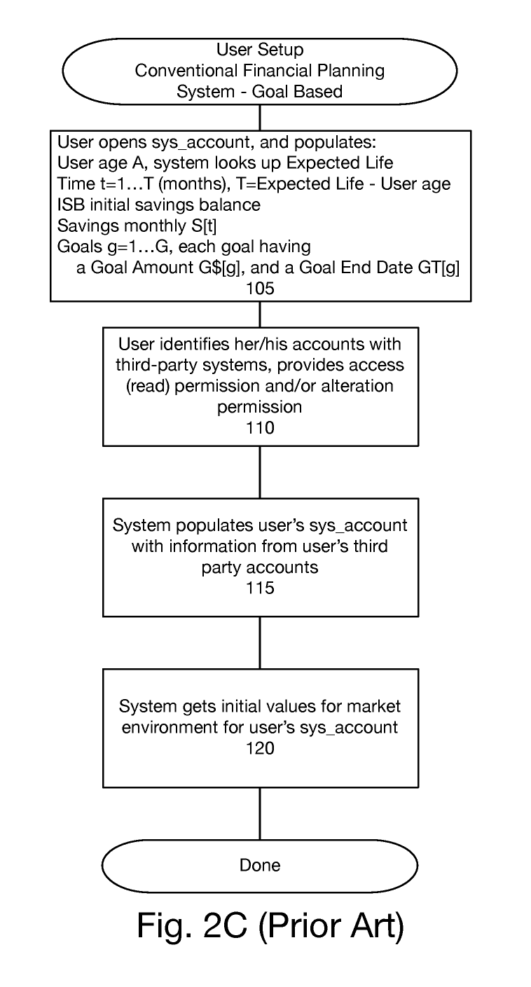

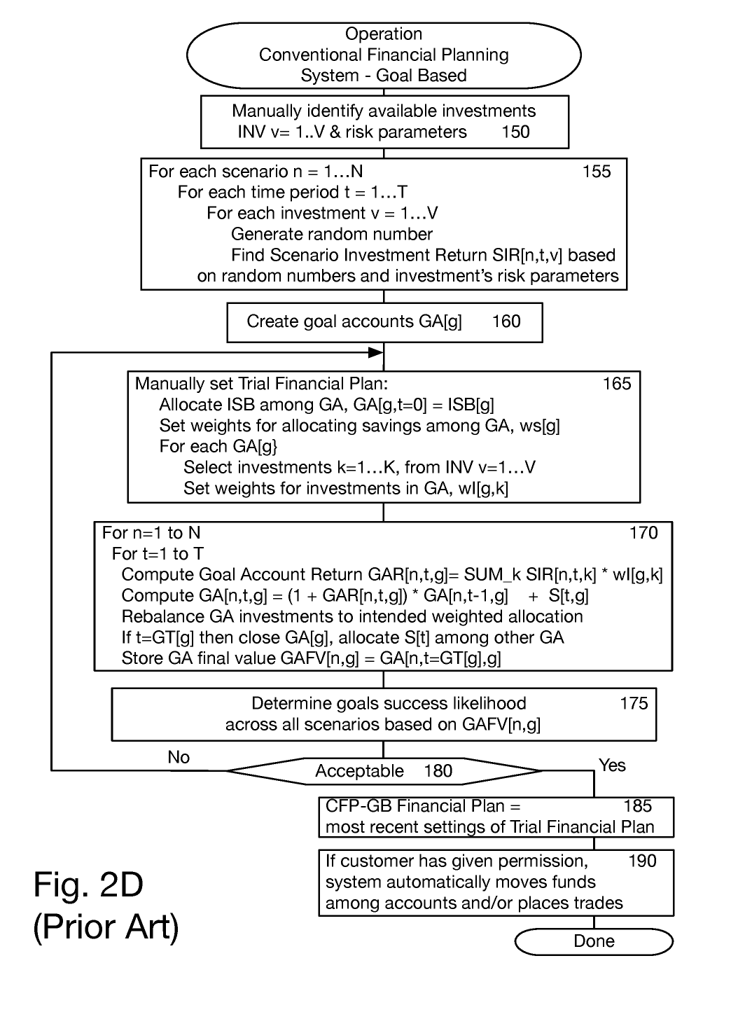

### DETAILED DESCRIPTION

As used herein and in the claims, a “life action” is an event affecting the user's financial plan; a life action may have a one-time effect or a periodic effect or a combination thereof. Life actions represent the reality of a user's financial life. Examples of life actions include: a salary from a job, an expected inheritance in the future, rent payments to the user's landlord, rental income from the user's properties, and so on.

As used herein and in the claims, a “goal” is an uncommitted life action. Goals represent what the user wants. When a user commits to a goal in her financial plan, the goal becomes a life action. A goal has a cost or range of costs, and has a desired timeframe expressed as a particular start date and a particular duration, or as a range of start dates and a particular duration. Examples of goals include retirement, tuition for the user's child, home purchase, charitable gift or endowment, and so on. A “legacy goal” is a one-time cost that occurs at the user's death, such as leaving an inheritance.

As used herein and in the claims, a “life object” is either a “life action” or a “goal”.

One problem with prior art financial planning systems is that the system tries to fund all goals, which often leads to all goals being unfunded.

An advantage of the present invention is that the financial planning system is able to choose which goals to fund. This is a huge improvement, as it leads to outcomes having at least some successfully funded goals, instead of all goals being unfunded. This advantage ensues from the technique of having a user specify all of his or her goals, with associated priority. Initially, the system regards all goals as “uncommitted”. As the system decides that a goal is affordable, the system changes that goal to “committed”.

A goal is modelled as an initial cost, optionally followed by periodic recurring costs, possibly ending at a particular date. Each goal has a user-specified priority, with higher priority goals being funded before lower priority goals. At least one highest priority goal must be specified. The present system provides templates for modelling goals such as retirement, home purchase (initial, mortage payment, real estate tax payments, resale value or annual increase, percent used for business), vehicle purchase (vehicle cost, vehicle lifetime, initial payment, loan payments, insurance payments, operating cost payments, loan duration, annual decrease, percent used for business), vehicle lease, child's college, child's wedding, and a free-form template; the non-free-form templates automatically check “reasonableness” such as requiring that the start date precede the end date.

In some embodiments, a goal template can specify a relationship between this goal and another life object. For instance, the retirement template may identify a job life object and specify that the job ends when retirement begins.

Another problem with prior art financial planning systems is that all goals are the same priority, which forces the user to manually impose priority, such as by first running the system with highest priority goals, and only after these succeed, can the user move on to other goals. This is inefficient.

Another advantage of the present invention is that the user is able to assign priorities to goals, so the system automatically achieves goals in accordance with the user's priorities, and the user is saved from executing multiple iterations of the system to find out how many goals are achievable. In one embodiment, multiple goals can be specified at the same priority. In another embodiment, only one goal can be specified at each priority, forcing the user put his or her goals into a priority sequence. In some embodiments, temporal or value portions of a goal can be specified with different priority levels; the system then represents these as different goals.

A further problem with prior art financial planning systems is that goals can be specified only for a fixed duration, and for a particular cost. This is extremely inefficient for a user, since the user must manually figure out what is achievable for goals that can vary in time and/or cost, leading the user to multiple executions of the financial planning system.

A further advantage of the present invention is that the user is able to specify goals having a variable timeframe and/or a variable cost, so the system automatically can be lavish or frugal depending on a simulation outcome and/or a user's goal flexibility.

Yet another problem with prior art financial planning systems is that the investment allocation remains constant over the user's lifetime.

Yet another advantage of the present invention is that the investment allocation may change over a user's lifetime. In one embodiment, the desired investment allocation is defined independent of the user's life actions. In another embodiment, the desired investment allocation changes in response to one or more of the user's age, life actions and total wealth.

The present financial planning system calculates priority-level benchmarks, such as “minimum wealth to achieve goals” (MWAG), based on the goals at each priority level. The benchmarks are a family of curves, with one curve for each goal priority level. The lowest value curve corresponds to the highest priority goal spending. The second lowest value curve corresponds to the highest priority curve plus the second highest priority goal spending. The third lowest value curve corresponds to the second lowest level curve plus the third highest priority goal spending, and so on. In this embodiment, the minimum wealth to achieve goals benchmark assumes that, for a goal having a time range, the goal begins at the latest possible time; and assumes that, for a goal having a value range, the minimum value is used.

If a goal has a range of values, the range values are divided into sub-goals, with a minimum wealth to achieve goals curve for each sub-goal.

For each Monte Carlo scenario, corresponding to one possible future scenario of investment returns, the system chooses which goals to fund based on comparison of the current wealth with the minimum wealth to achieve goals: lower-priority goals are funded only when aggregate wealth is sufficient to fund all higher priority goals. Then, the likelihood of success for each goal is summed across all scenarios.

If these scenarios result in an acceptable plan, and if the user has given permission, the financial planning system then acts on this plan, such as by moving funds among accounts or placing securities trades.

If these scenarios do not result in an acceptable plan, then the user must change his or her goals, or income expectations. Advantageously, the user does not consume time running scenarios with re-ordered existing goals, as the system has already done the best that can be done with the existing goals.

The present system can be used for at least three purposes: asset management, money management, and consumption advice.

Asset management is useful for wealthy people, who seek a better investment outcome.

Money management is useful for day-to-day financial planning, indicating which streams of expenses should be adjusted or sequenced. Particularly, as goals are completed, the optimal asset allocation can change.

Consumption advice is useful for buying and selling items having significant financial value to the user, such as a home or vehicle. The present system helps ensure that the user buys something appropriate to their wealth: not too cheap and not too expensive.

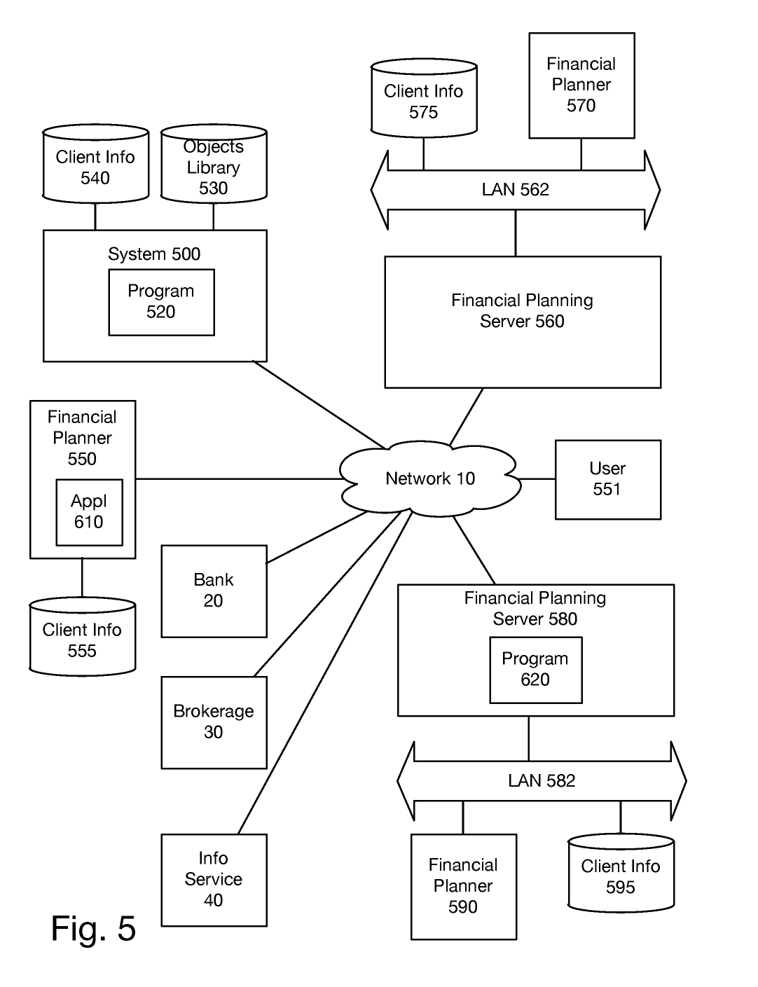

FIG. 5 shows configurations for a financial planning system according to the present invention. Five configurations of the financial planning system are depicted.

Network 10 is any suitable communication network such as the Internet. Financial planning system 500, financial planner 550, financial planning servers 560, 580, bank 20, brokerage 30, information service 40 and user 551 are each coupled to network 10 via a suitable communication channel. Generally, financial planner 550 configures the financial planning system, and then uses the financial planning system on behalf of his client or customer, or enables his client or customer to use the financial planning system directly. User 551 is a client or customer of financial planner 550 that directly uses the financial planning system, as configured by financial planner 550. As used herein, “user” means either financial planner 550 and/or user 551, as will be apparent from context.

First, a solo financial planner may execute planning software 610 on her personal computer 550 having locally stored client information 555, and may use Internet 10 to access client accounts at banks 20 or brokerages 30. The financial planner may use information service 40 to obtain, e.g., quotes for current market valuation of client investments.

Second, in a client-server configuration, a solo financial planner having client planning program 610 (instead of a full planning system) executing on her personal computer 550, with locally stored client information 555, can use financial planning server 500 executing server planning program 520. In a variation, financial planning server 500 enables the financial planner to store her client's information in client information storage 540 coupled to financial planning server 500. Instead of a personal computer, the financial planner can use a tablet computer or a smartphone or other suitable device. Typically, personal computer 550 uses a public network, such as Internet 10, to communicate with server 500.

Life objects library 530 includes goal templates and life action templates. Each template provides fields for financial modelling of that type of goal or life object, including priority, date and cash flow. Examples of life objects include job (periodic salary, periodic bonus, social security earnings), trust fund income, alimony income, expected inheritance, social security payments and life insurance.

In some embodiments, the system suggests financing options such as vehicle loans, mortgage refinancing, good times to buy or sell lower priority life objects such as a second car to achieve higher priority goals.

Third, in a software-as-a-service (SaaS) configuration otherwise similar to the client-server configuration, a solo financial planner uses personal computer 550 has an operating system and browser, but lacks special software; client data can be stored in local storage 555 or in server client storage 540. Instead of a personal computer, the financial planner can use a tablet computer or a smartphone or other suitable device.

Fourth, an employee financial planner uses personal computer 590 on the premises of their employer, which operates financial planning server 580 executing financial planning program 620. Local area network (LAN) 582 provides the physical connection from personal computer 590 to financial planning server 580. The client information is stored in storage device 595 that is connected to LAN 582. Financial planning server 580 may use the Internet to access client accounts at banks or brokerages. Instead of a personal computer, the financial planner can use a tablet computer or a smartphone or other suitable device. Financial planning program 620 operates according to a SaaS configuration; in a variation, financial planning program 620 operates according to a client-server configuration.

In a further variation, the employee financial planner is not on her employer's premises, and uses Internet 10 to communicate with financial planning server 580 executing financial planning program 620.

Fifth, an employee financial planner uses personal computer 570 on the premises of their employer, which operates financial planning server 560. Local area network (LAN) 562 provides the physical connection from personal computer 570 to financial planning server 560. The client information is stored in storage device 575 that is connected to LAN 562. Financial planning server 560 may use the Internet to access client accounts at banks or brokerages. Instead of a personal computer, the financial planner can use a tablet computer or a smartphone or other suitable device.

Financial planning server 560 is essentially a proxy, so that the employee financial planner can use financial planning program 520 executing on financial planning server 500. Financial planning program 520 operates according to a SaaS configuration; in a variation, financial planning program 520 operates according to a client-server configuration, with the client program located at financial planning server 560 or financial planner computing device 570. In a variation, financial planning server 500 enables the financial planner to store her client's information in client information storage 540 coupled to financial planning server 500.

In a further variation, the employee financial planner is not on her employer's premises, and uses Internet 10 to communicate with financial planning server 560.

Each of personal computer 550, 570, 590 and server 500, 560, 580 is a general purpose computer programmed according to the present invention. Connections to Internet 10 may be wireline or wireless.

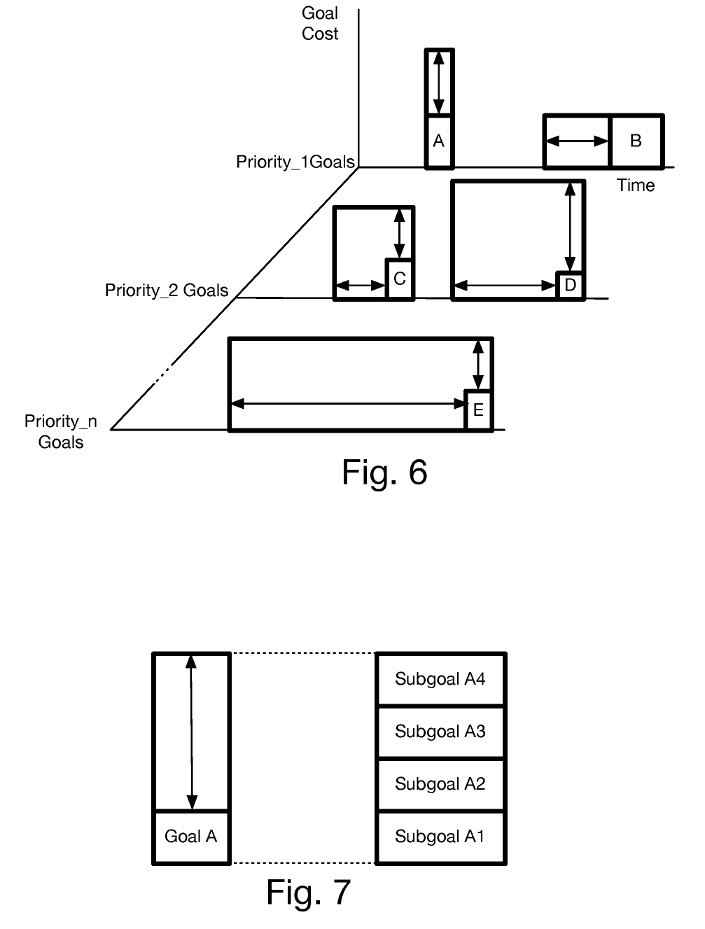

FIG. 6 is a chart showing prioritized goals with time and cost variability. Importantly, the present invention begins by automatically gathering more information from the user than prior art systems. The user can define as many goal priorities as she wishes, with at least one goal at each priority level. Priority 1 goals are the most important, and there must be at least one priority 1 goal.

Each goal has at least a start time, a duration of spending, and an amount spent. The financial planning system has a monthly granulation, that is, the Monte Carlo simulations are performed on a month-by-month basis, so the amount spent per goal can be specified per month of the duration. However, typically the user is interested in a lifetime plan, so the goal spending is specified per year. If the spending needs to change over the duration of the goal, the goal should be defined as two goals at the same priority level, preferably with no other goals at this priority level.

Additionally, the start time of a goal can be specified as a range, and/or the cost of a goal can be specified as a range.

FIG. 6 shows five exemplary goals.

At Priority 1, Goal A, such as college tuition for a child, has a duration of a few years, and a cost specified as a range, corresponding to (a) uncertainty as to future tuition cost and (b) uncertainty as to what percent of tuition that the parent will pay.

Also at Priority 1, Goal B, such as retirement, shows flexibility in start date, with a fixed annual cost.

At Priority 2, Goal C, such as a home downpayment, shows flexibility in start date and in cost, corresponding to the user's desire to own a home but not being picky about when or its type.

Also at Priority 2, Goal D, such as a charitable gift, shows flexibility in start date and in cost, corresponding to the user's desire to gift something appropriate for her future circumstances.

Goals at priorities 3 to (n−1) are not shown.

At Priority (n), Goal E, such as a boat, shows flexibility in start date and in cost. By specifying this as the lowest priority goal, the user indicates that she wants this goal only if she becomes unexpectedly wealthy.

Time variability in a goal will now be discussed.

When a goal has a time range specified for its start date, the benchmark calculation (such as a minimum wealth to achieve goals calculation) assumes that the latest time in the range is the start date of the goal. For each Monte Carlo simulation, time variable goal funding can occur according to different techniques. In one technique, as soon as the user's wealth exceeds the minimum wealth to achieve goals for that goal, it will be funded. In another technique, the latest start date of the goal is always used. A further technique, discussed below, may be used if the goal also has value variability.

Value variability in a goal will now be discussed.

FIG. 7 shows a goal with value variability split into discrete sub-goals. In one embodiment, the user specifies how many sub-goals should be associated with the goal, and the financial planning system evenly divides the range over the number of sub-goals. In another embodiment, the user specifies how many sub-goals and the value of each sub-goal. In a further embodiment, the financial planning system automatically divides each range into a predetermined number of sub-goals, such as three. Other techniques are used in other embodiments.

For each Monte Carlo simulation, variable value goal funding can occur according to different techniques. In one technique, as soon as the user's wealth exceeds the minimum wealth to achieve goals for the lowest value sub-goal, it will be funded. If the goal also has time variability, the following technique may be used: at the soonest time that the least value sub-goal can be funded, the financial planning system estimates the benefit of waiting until the latest time of funding, and if the expected benefit exceeds a predetermined threshold then the financial planning system waits until the earlier of (a) when the highest value sub-goal can be funded, and (b) the latest time of funding, to decide at what time and level to fund this goal.

Creation of benchmark curves will now be discussed.

As used herein and in the claims, a benchmark is a value at a particular time that indicates whether an objective is or is not achievable, with an objective being either one goal or a set of goals having the same priority. The present financial planning system uses benchmarks to choose which user goals to fund.

In this embodiment, a “minimum wealth to achieve goals” (MWAG) technique is used to determine the benchmark curves. In other embodiments, other techniques are used to determine the benchmarks.

A second benchmark technique is to assume the most conservative returns on all investments, then project all cash flows, and via trial and error, adjust the initial starting wealth to achieve the goals at the highest priority level. This process is repeated with goals at the highest and next-highest priority level to achieve the initial starting wealth for the next benchmark. This is repeated for all priority levels to achieve all benchmark curves.

A third benchmark technique is to re-run the entire set of Monte Carlo simulations so that the user's wealth at the time of death is zero.

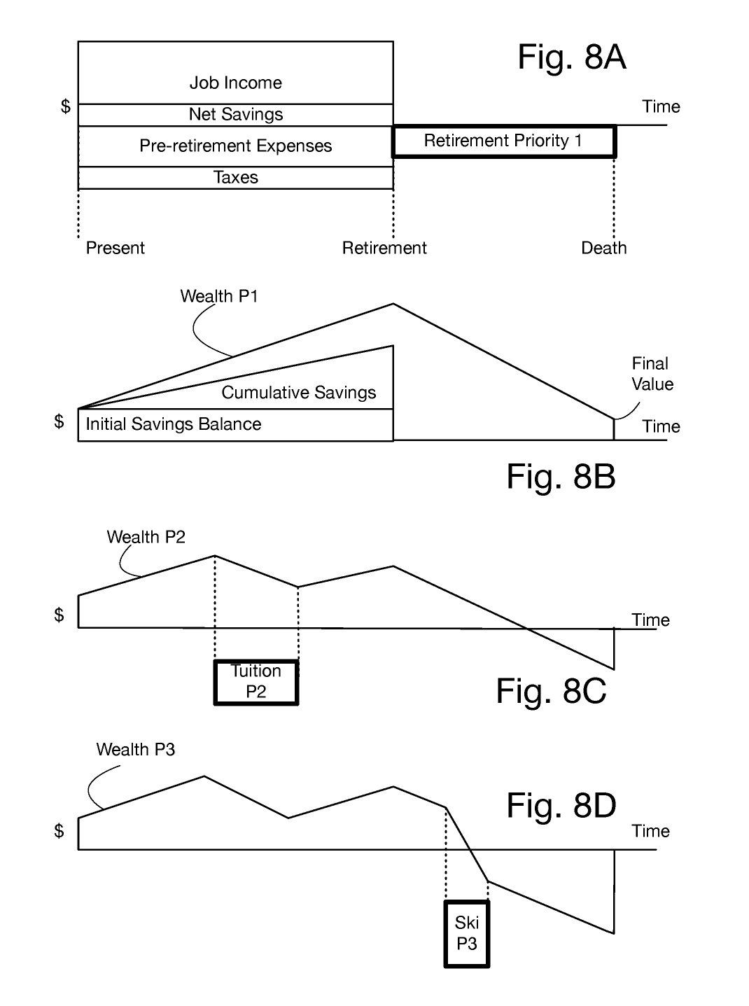

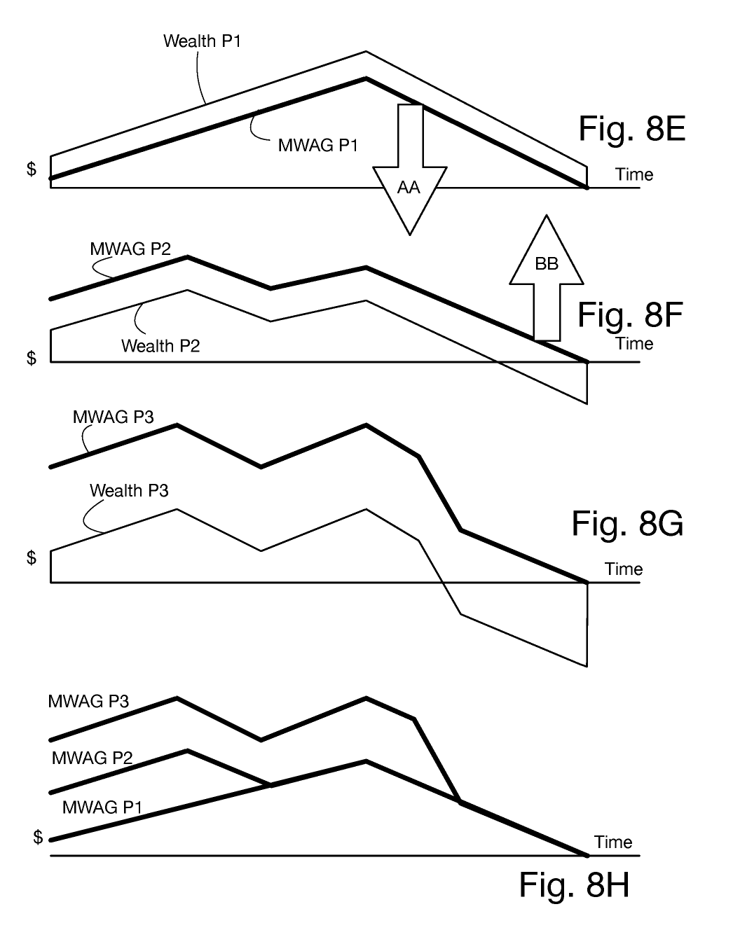

FIG. 8A-8H are graphs showing generation of MWAG curves. FIGS. 8A-8D represent the user's projected hypothetical financial activity, while FIGS. 8E-8H show how MWAG curves are obtained from the hypothetical financial activity.

Assume that the user has one priority 1 goal: retirement; one priority 2 goal: tuition for the user's only child; and one priority 3 goal: multi-country ski trip. During retirement, the user's only expenses are retirement expenses. Assume further that the user has income only from a job and investments.

FIG. 8A shows the user's life actions, and priority 1 goal of retirement, summed to yield total income, total expenses, total taxes and total savings over the user's financial life, beginning at the present and ending at the user's death:

Savings[t,p]=Income[t,p]−Expenses[t,p]−Taxes[t,p] (equation 11)
where t=Present . . . Death
p=priority level

FIG. 8B shows the user's initial savings balance (ISB), the user's cumulative savings, the user's investment income and the user's hypothetical Wealth over the user's financial life:

Cumulative_Savings[t,p]=Σ_{t=Present}^{Death}Savings[t,p] (equation 12)

Invest_Income[t,p]=Invest_return*(ISB+Cumulative_Savings[t−1,p]) (equation 13)

Wealth[t,p]=ISB+Cumulative_Savings[t,p]+Invest_Income[t,p] (equation14)

The hypothetical wealth includes investment income that assumes a fixed rate of return for the investments for the planning period, as in conventional financial planning systems. This fixed rate of return may represent the sum of the rates of return of several investments with respectively different rates of return.

In another embodiment, instead of a fixed rate of return for the investments, a set of investment rate of return Monte Carlo simulations is generated for the financial planning period, and the average simulated rate of return at each period is used for the investments.

Final Value[p] refers to the user's wealth at the time of death, Wealth[t=Death, p]. In this case, the ISB and Final Value[p=1] of the Wealth P1 are positive. However, in other cases, the ISB and/or Final Value may be negative. The ISB could be negative if the user owes money (e.g., student loans). The Final Value could be negative if the user is destitute or has her wealth in illiquid assets that are not included in Wealth as defined here.

FIG. 8C shows the effect of adding the priority 2 goals—child's college tuition—to the user's wealth incorporating priority 1 goals, yielding the user's wealth incorporating priority 1 and priority 2 goals, Wealth P2=Wealth P1+goals [p=2]. The user's wealth decreases due to spending on priority 2 goals, so that Final Value [p=2] becomes negative.

FIG. 8D shows the effect of adding the priority 3 goals—ski trip—to the user's wealth incorporating priority 1 and 2 goals, yielding the user's wealth incorporating priority 1, priority 2 and priority 3 goals, Wealth P3=Wealth P2+goals [p=3]. The user's wealth decreases due to spending on priority 3 goals, so that Final Value [p=3] becomes more negative than Final Value [p=2].

FIG. 8E shows MWAG P1 based on Wealth P1. The MWAG curve is approximately the Wealth curve slid up or down along the y-axis (value) such that the Final Value of the MWAG curve is zero. The sliding corresponds to adjusting the Initial Savings Balance, which also affects lifetime Investment Income, explaining why vertical sliding is only an approximation. Any suitable technique may be used to determine the ISB, such as the bisection method or the Newton method.

The bisection method bisects an interval, then selects a subinterval for further processing. In this example, the MWAG curve approximately results from sliding the Wealth curve down, so the bisection method begins with the interval defined by ISB of Wealth P1 and zero, and iterates, generating a “Wealth” curve at each iteration until the Final Value of the “Wealth” curve is within a predetermined threshold, such as 2% of the Final Value of Wealth P1, of zero, and then this “Wealth” curve is the MWAG P1 curve.

The Newton method finds successively better approximations based on adjusting an initial guess by subtracting a function of the initial guess divided by the first derivative of the function of the initial guess to yield a second guess, then iterating by adjusting successive guesses until the Final Value of the “Wealth” curve is within a predetermined threshold, such as 2% of the Final Value of Wealth P1, of zero, and then this “Wealth” curve is the MWAG P1 curve.

FIG. 8F shows the MWAG P2 curve based on the Wealth P2 curve. MWAG P2 is obtained from Wealth P2 in a similar manner as MWAG P1 was obtained from Wealth P1. Note that since the Final Value of Wealth P2 is negative, the Wealth P2 curve is approximately slid upwards to yield the MWAG P2 curve.

FIG. 8G shows the MWAG P3 curve based on the Wealth P2 curve. MWAG P3 is obtained from Wealth P3 in a similar manner as MWAG P1 was obtained from Wealth P1. Note that since the Final Value of Wealth P3 is negative, the Wealth P3 curve is approximately slid upwards to yield the MWAG P3 curve.

FIG. 8H shows the MWAG P1, P2, P3 curves from FIGS. 8E-8G on one graph. The initial point keeps rising, reflecting money needed for goals at successive priority levels. It will be understood that the shape of the MWAG curves is highly dependant on the user's financial activity, that is, life actions and goals.

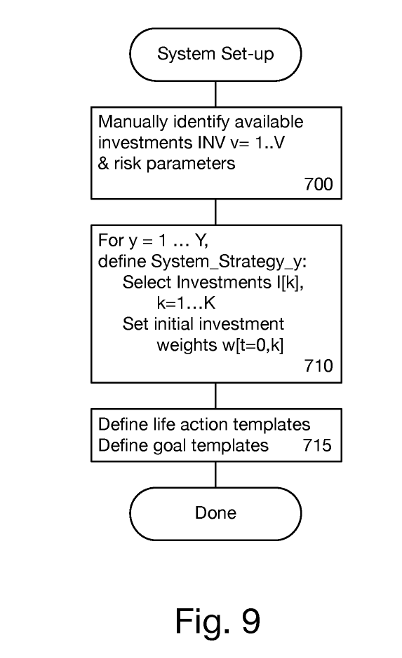

FIG. 9 is a flowchart showing system set-up in a financial planning system according to the present invention. The information created during set-up is stored in a suitable storage, such as client storages 540, 555, 575, 595 and objects library 530, shown in FIG. 5.

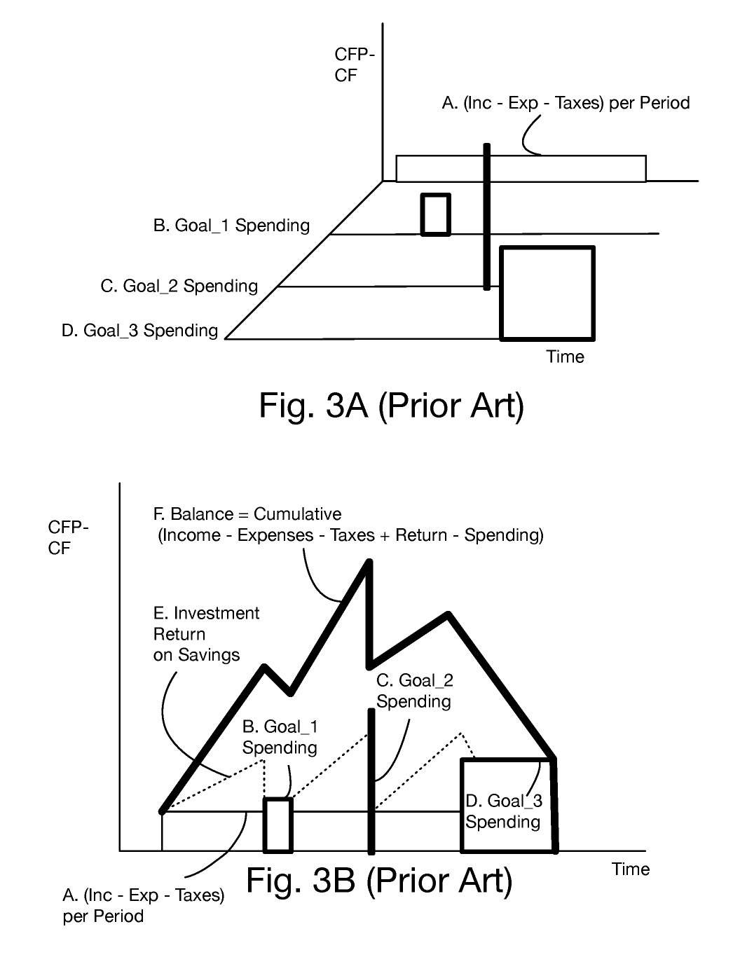

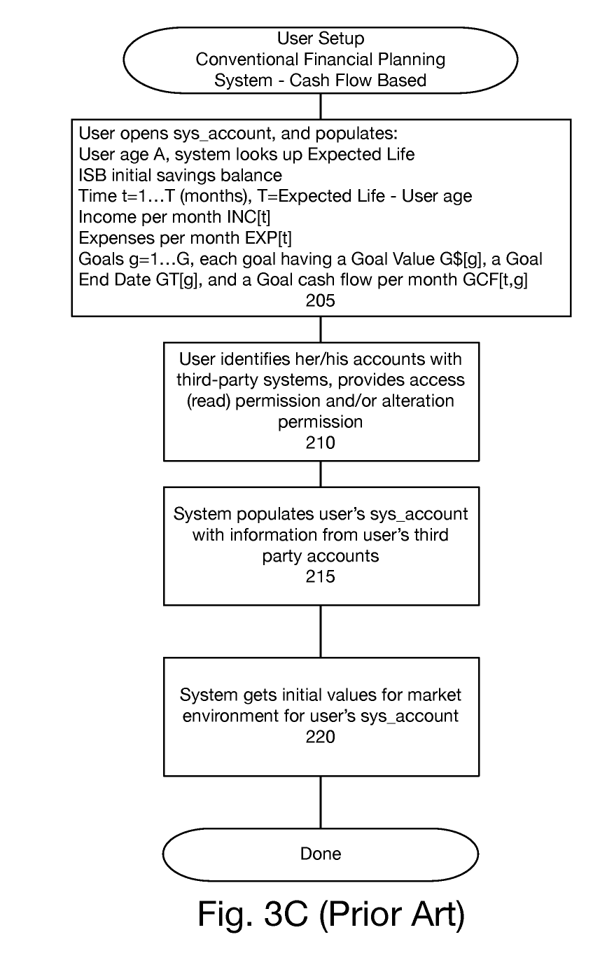

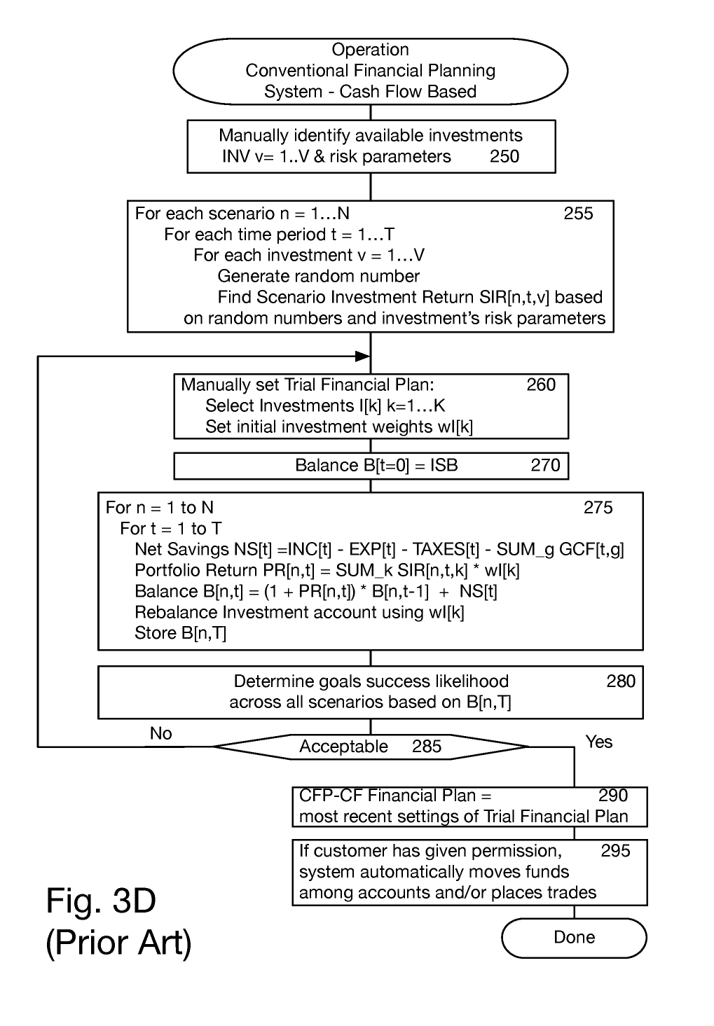

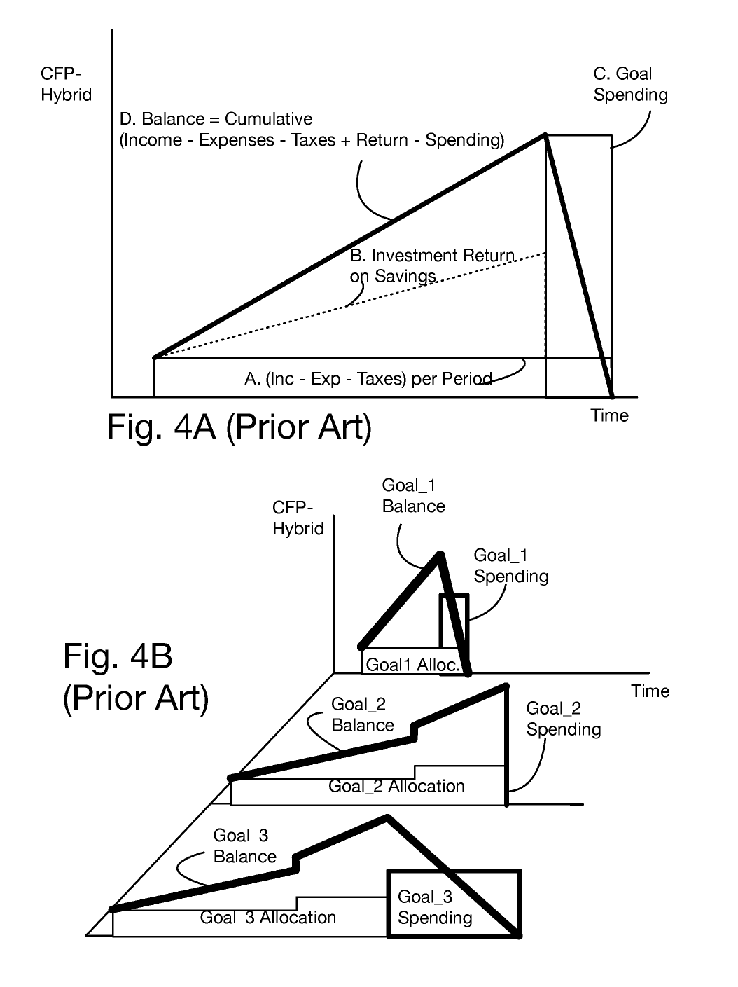

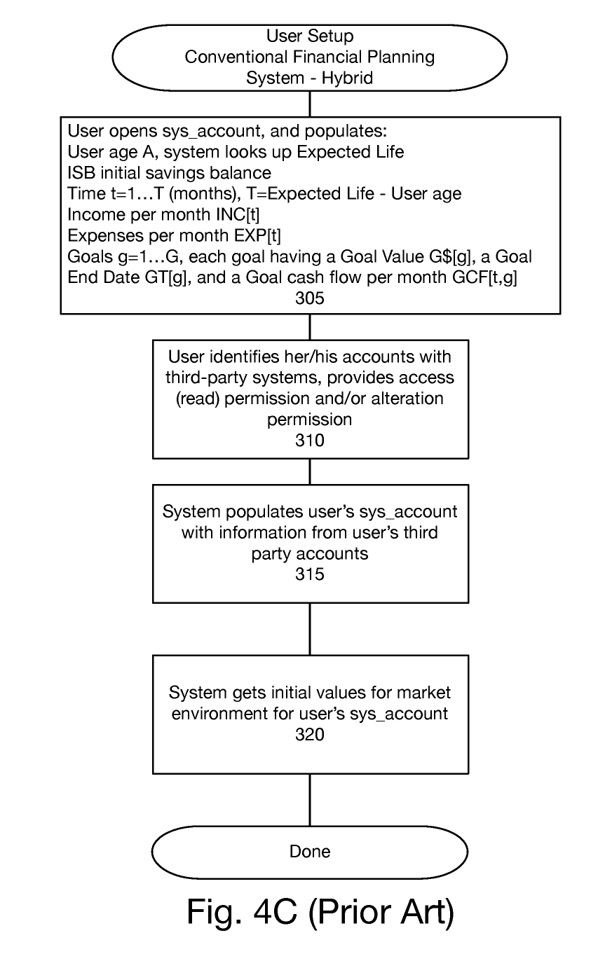

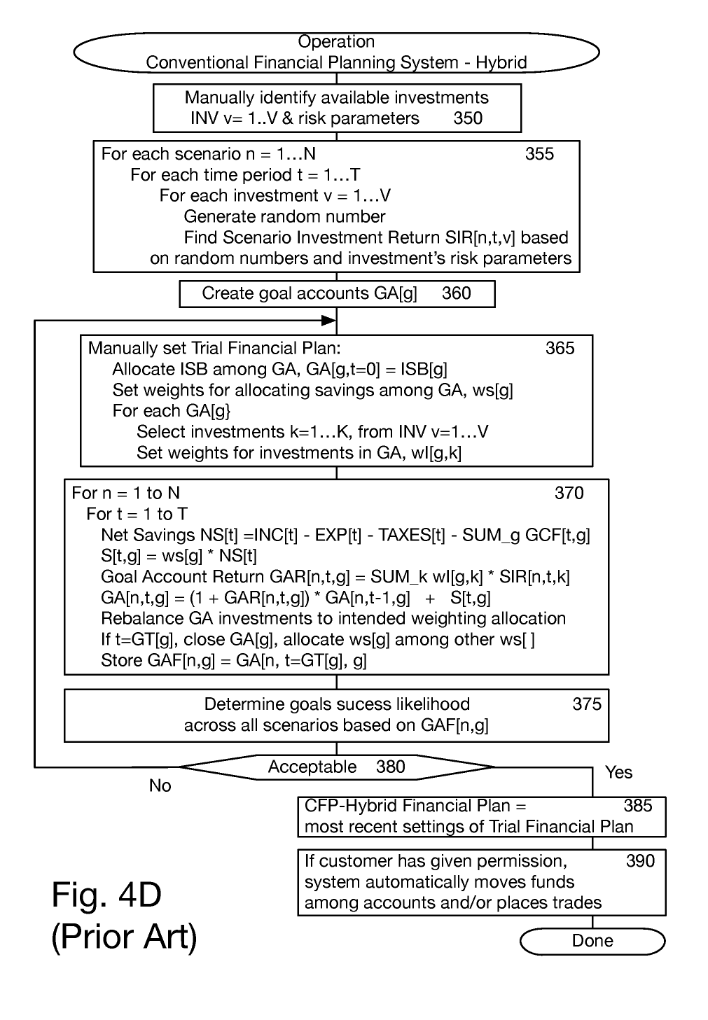

At step 700, the financial planner manually identifies the available investments v=1 . . . V and their associated risk parameters. This is similar to step 250 of FIG. 3D.

At step 710, the financial planner defines up to Y strategies. For each strategy y, y=1 . . . Y, the financial planner selects K investments, and sets the initial investment weights, that is, the portion of savings to be allocated to each investment. Each initial investment weight is a fraction between 0 and 1, with the total of the weights summing to 1.0. For example, if K=3, then the initial investment weights might be [0.33 0.33 0.34] for even weighting, or [0.2 0.2 0.6] for uneven weighting.

The present system enables the investment allocation to change over time. Typical strategies favor higher risk investments when the client is younger, and lower risk investments when the client is older. A conventional “target date fund” automatically changes the investment allocation of a portfolio based on the time remaining until the target date of the fund; investors are supposed to choose a target date close to their desired retirement. Prior art financial planning systems accommodate target date funds, if at all, via a bundle of predefined scenarios, such as about 50 scenarios, instead of Monte Carlo simulated scenarios.

The present financial planning system essentially customizes a target date fund to the user, rather than requiring the user to pick a fund closest to her needs. The user's retirement date can be flexible, whereas conventional target date funds lack time variability in the target date.

The present financial planning system accommodates target date funds via Monte Carlo simulated scenarios, such as about 1,000 scenarios, with the portfolio weights of investments varying over time, thereby better modelling risk. For instance, assume that the k=1 investment has high risk, the k=2 investment has medium risk and the k=3 investment has low risk, and that t indicates the year of the financial plan (t=0 is the initial condition). The following system investment strategy y(1) changes from high risk to low risk as the client ages: [t=0, 1.0 0 0], [t=10, 0.8 0.2 0], [t=20, 0.5 0.5 0], [t=30, 0.2 0.5 0.3], [t=40, 0 0.3 0.7]. The following system investment strategy y(2) changes from medium to low risk as the client ages: [t=0, 0.3 0.7 0], [t=10, 0.2 0.7 0.1], [t=20, 0.1 0.5 0.4], [t=30, 0 0.3 0.7], [t=40, 0 0 1.0].

In another embodiment, the desired investment allocation changes in response to one or more of the user's age, life actions (goal completion) and total wealth. For example, after the goal of paying for a child's college tuition is met, the user may be willing to assume more risk with their income that had gone towards tuition.

At step 715, the financial planner defines the life object templates, comprising the life action templates and goal templates, to be available to users. A goal template has a field for priority level. A life action template lacks a priority level. Usually, the financial planner selects from a library of life object templates. The financial planner may also create customized life object templates. The life object templates automatically check “reasonableness” such as requiring that the start date precede the end date.

A liquidatable asset is a type of life action.

Table 2 shows a general life object template; other fields may be added. The life object template has a row for each field. Each row includes a field number, a field status (required or optional), a field name, and a field value supplied by the template creator or by the user. Income fields 8A-8B are comparable to Cash Flow fields 9A-9E, that is, a template that uses Income does not use Cash Flow, while a template that uses Cash Flow does not use Income.

TABLE 2
General Life Object Template

| Field | | | |
|---|---|---|---|
| number | Field status | Field Name | Field Value |
| 1 | Required | Life Object Template Name | |
| 2 | Required | Life Object Template Number | |
| 2A | Optional | Goal-inherent-priority-level | |
| 3 | Optional | User-supplied Life Object Name | |
| 4 | Optional | User-supplied free-form descriptive text | |
| 5 | Optional | Goal-Priority level | |
| 6 | Required | Start-date-fixed-date | |
| | (pick 1 of 3) | Start-date-contingent-on-event | |
| | | Start-date-open-date & Start-date-close-date | |
| 7 | Required | End-date-fixed-date | |
| | (pick 1 of 3) | End-date-contingent-on-event | |
| | | Duration & t units (yrs/months/weeks/days) | |
| 8A | Optional | Income-Initial-value-fixed | |
| | (pick 1 of 2) | Inc-Init-val-min & Inc-Init-val-max & Inc-tiers | |
| 8B | Optional | Income-Periodic-value-fixed & growth | |
| | (pick 1 of 2) | Inc-Per-val-min & Inc-Per-val-max & Inc-tiers | |
| 9A | Optional | Cash Flow Fields: Periodic (monthly, quarterly, | |
| | (pick 1 of 3) | annual) cash flow amounts | |
| 9B | Optional | Cash Flow Fields: Growth-rate amount and type | |
| | (pick 1 of 2) | (Nominal or Percentage) | |
| 9C | Optional | Cash Flow Fields: Growth cap amount and type | |
| | (pick 1 of 2) | (Nominal or Percentage) | |
| 9D | Optional | Cash Flow Fields: Variability amount and type | |
| | (pick 1 of 2) | (Nominal or Percentage) | |
| 9E | Optional | Cash Flow Fields: Tax Classification of cash | |
| | (pick 1 of 5) | flow: For-positive-cash-flows(Taxable/Non- | |
| | | taxable/Tax-deferred) and For-negative-cash- | |
| | | flows(Deductible/Non-deductible) | |
| 10A | Optional | Expense-Initial-value-fixed & growth | |
| | (pick 1 of 2) | Exp-Init-val-min & Exp-Init-val-max & Exp- | |
| | | tiers | |
| 10B | Optional | Expense-Periodic-value-fixed | |
| | (pick 1 of 2) | Exp-Per-val-min & Exp-val-max & Exp-tiers | |
| 11 | Optional | Final-value-fixed | |
| | (pick 1 of 2) | Value-increase/decrease-per-period & | |
| | | fixed/pctge | |
| 12A | Optional | Asset Fields: Market Value | |
| 12B | Optional | Asset Fields: Cost Basis | |
| 12C | Optional | Asset Fields: Appreciation/depreciation rate | |
| 12D | Optional | Asset Fields: Income Cash Flows (periodic | |
| | (pick 1 of 2) | amount and type nominal/percentage yield) | |
| 12E | Optional | Asset Fields: Expenses Cash Flows (periodic | |
| | (pick 1 of 2) | amount and type nominal/percentage yield) | |
| 12F | Optional | Asset Fields: Liquidity Restrictions | |
| | (pick 1 of 3) | (Illiquid/RestrictedTime/LiquidityHaircut) | |
| 12G | Optional | Asset Fields: Liquidation Priority LPn (LPn | |
| | | means allowed to liquidate only for funding of | |
| | | goals of priority Pn or higher) | |
| 13 | Optional | Tax-status-deductible/deferred/taxable/non- | |
| | | taxable | |
| 14 | Optional | Expected-Selling-duration-liquidity | |
| 15 | Optional | Liquidation-for-goals-priority | |
| 16 | Optional | Liquidity-restriction | |
| 17 | Optional | Loan-type-amortizing/balloon/simple | |
| 18 | Optional | Loan-interest-rate-fixed | |
| | (pick 1 of 2) | Loan-interest-rate-reference & spread | |
| 19 | Optional | Liability Fields: Notional Amount | |
| 20 | Optional | Liability Fields: Type (Term Loan, Amortizing | |
| | (pick 1 of 3) | Loan, Line of Credit) | |
| 21 | Optional | Liability Fields: Maturity Date or Term to | |
| | (pick 1 of 2) | Maturity | |
| 22 | Optional | Liability Fields: Interest Rate (fixed rate or | |
| | (pick 1 of 2) | floating spread over a reference benchmark rate) | |
| 23 | Optional | Liability Fields: Prepayment Type | |
| | (pick 1 of 3) | (disallowed/allowed/with penalty) | |

Table 3 shows an expected inheritance life action represented in a life object template. Field 1 was supplied by the financial planner and indicates an expected inheritance of a thing. Field 2 was supplied by the financial planner and indicates the template number in a library, such as life actions library 530. The financial planner selected the other fields for this life action. The user provides the field values. Field 3 shows the user named this life action “Aunt Mary bequest”. Field 4 shows the user described this bequest as “Kahlo painting”. There is no priority level (no field 5), which means this is a life action not a goal. Field 6 shows that the user expects this inheritance to begin between Jan. 1, 2025 and Dec. 31, 2030 (whenever Aunt Mary dies), and field 7 shows that the user expects this inheritance to end on the same day. Field 8A shows that the user expects the inheritance to have a value of $800,000. Field 14 shows that the user expects it will take one year to sell this inheritance. Field 15 indicates that the user is willing to liquidate this asset to achieve goals of priority 1 or 2, but not lower priority goals. The user considers Aunt Mary's Kahlo painting to have some sentimental value, but is willing to liquidate the painting to achieve her high priority goals.

TABLE 3
Expected Inheritance Life Action

| Field | | | |
|---|---|---|---|
| number | Field status | Field Name | Field Value |
| 1 | Required | Life Object Template Name | Inheritance |
| 2 | Required | Life Object Template Number | 33 |
| 3 | Optional | User-supplied Life Object Name | Aunt Mary bequest |
| 4 | Optional | User-supplied free-form descriptive text | Kahlo painting |
| 6 | Required | Start-date-fixed-date | 20250101 & |
| | (pick 1 of 3) | Start-date-contingent-on-event | 20301231 |
| | | Start-date-open-date & Start-date-close-date | |
| 7 | Required | End-date-fixed-date | 1 day |
| | (pick 1 of 3) | End-date-contingent-on-event | |
| | | Duration & t units (yrs/months/weeks/days) | |
| 8A | Optional | Income-Initial-value-fixed | US$ 800,000 |
| | (pick 1 of 2) | Inc-Init-val-min & Inc-Init-val-max & Inc-tiers | |
| 14 | Optional | Expected-Selling-duration-liquidity | 1 year |
| 15 | Optional | Liquidation-for-goals-priority | 2 |

Table 4 shows a tuition goal represented in a life object template. Field 1 was supplied by the financial planner and indicates tuition. Field 2 was supplied by the financial planner and indicates the template number in a library, such as life actions library 530. The financial planner selected the other fields for this life action. The user provides the field values. Field 3 shows the user named this life action “Juliet tuition”. Field 5 shows the user gave this goal a priority of “2”. Field 6 shows that the user expects this goal to begin between Sep. 1, 2024 (Juliet may graduate from high school in three years) and Sep. 1, 2026 (Juliet may graduate from high school in four years then take a year off). Field 7 shows that this goal has a duration of four years. Field 10B shows that this goal has a value range of 30,000 per year to 120,000 per year, corresponding to the user's uncertainty over whether Juliet will live at home and attend a state school, or will attend an elite university and live there, or something in-between. Field 10B also shows that this goal has three tiers, meaning that the user is effectively specifying tutition at 30,000 per year; 75,000 per year (midpoint of lowest and highest values); or 120,000 per year, as priority 2 goals.

TABLE 4
Tuition Goal

| Field | | | |
|---|---|---|---|
| number | Field status | Field Name | Field Value |
| 1 | Required | Life Object Template Name | Tuition |
| 2 | Required | Life Object Template Number | 212 |
| 3 | Optional | User-supplied Life Object Name | Juliet tuition |
| 5 | Optional | Goal-Priority level | 2 |
| 6 | Required | Start-date-fixed-date | 20240901 & |
| | (pick 1 of 3) | Start-date-contingent-on-event | 20260901 |
| | | Start-date-open-date & Start-date-close-date | |
| 7 | Required | End-date-fixed-date | 4 years |
| | (pick 1 of 3) | End-date-contingent-on-event | |
| | | Duration & t units (yrs/months/weeks/days) | |
| 10B | Optional | Expense-Periodic-value-fixed | 30,000 & 120,000 |
| | (pick 1 of 2) | Exp-Per-val-min & Exp-val-max & Exp-tiers | & 3 |

Alternatively, the user might specify tuition at 30,000 per year as a priority 2 goal; tuition at 75,000−30,000=45,000 as a priority 3 goal; and tuition at 120,000−75,000=45,000 as a priority 4 goal; this scenario corresponds to the user wanting to pay some tuition as a priority 2 goal, but pay all of the most expensive tuition only if all other goals at priorities 2 and 3 are satisfied. Perhaps Juliet will need student loans or a job, if the user has other goals.

Table 5 shows a student loan life action represented in a life object template.

TABLE 5
Student Loan Life Action

| Field | | | |
|---|---|---|---|
| number | Field status | Field Name | Field Value |
| 1 | Required | Life Object Template Name | TermLoanAmortizing |
| 2 | Required | Life Object Template Number | 154 |
| 3 | Optional | User-supplied Life Object Name | Student Loan |
| 4 | Optional | User-supplied free-form descriptive text | MBA Tuition |
| | | | Payment |
| 6 | Required (pick 1 | Start-date-fixed-date | 20150101 |
| | of 3) | | |
| 7 | Required (pick 1 | Duration & t units | 10 years |
| | of 3) | (yrs/months/weeks/days) | |
| 9E | Optional (pick 1 | Cash Flow Fields: Tax Classification of | Taxable/Non- |
| | of 5) | cash flow: For-positive-cash- | deductible |
| | | flows(Taxable/Non-taxable/Tax-deferred) | |
| | | and For-negative-cash- | |
| | | flows(Deductible/Non-deductible) | |
| 19 | Optional | Liability Fields: Notional Amount | $120,000 |
| 20 | Optional (pick 1 | Liability Fields: Type (Term Loan, | Amortizing Loan |
| | of 3) | Amortizing Loan, Line of Credit) | |
| 21 | Optional (pick 1 | Liability Fields: Maturity Date or Term to | 10 years |
| | of 2) | Maturity | |
| 22 | Optional (pick 1 | Liability Fields: Interest Rate (fixed rate or | 6% |
| | of 2) | floating spread over a reference | |
| | | benchmark rate) | |
| 23 | Optional (pick 1 | Liability Fields: Prepayment Type | Allowed |
| | of 3) | (disallowed/allowed/with penalty) | |

Table 6 shows a rental property life action represented in a life object template.

TABLE 6
Rental Property Life Action

| Field | | | |
|---|---|---|---|
| number | Field status | Field Name | Field Value |
| 1 | Required | Life Object Template Name | RentalProperty |
| 2 | Required | Life Object Template Number | 123 |
| 3 | Optional | User-supplied Life Object Name | Apartment Rental |
| 4 | Optional | User-supplied free-form descriptive text | Investment Property |
| 6 | Required | Start-date-fixed-date | 20150101 |
| | (pick 1 of 3) | | |
| 7 | Required | Duration & t units (yrs/months/weeks/days) | 30 years |
| | (pick 1 of 3) | | |
| 9E | Optional | Cash Flow Fields: Tax Classification of cash | Non-deductible |
| | (pick 1 of 5) | flow: For-positive-cash-flows(Taxable/Non- | |
| | | taxable/Tax-deferred) and For-negative-cash- | |
| | | flows(Deductible/Non-deductible) | |
| 12A | Optional | Asset Fields: Market Value | $1,000,000 |
| 12B | Optional | Asset Fields: Cost Basis | $700,000 |
| 12C | Optional | Asset Fields: Appreciation/depreciation rate | 2% |
| 12D | Optional | Asset Fields: Income Cash Flows (periodic | 3% rental yield |
| | (pick 1 of 2) | amount and type nominal/percentage yield) | |
| 12E | Optional | Asset Fields: Expenses Cash Flows (periodic | −$850/mo nominal |
| | (pick 1 of 2) | amount and type nominal/percentage yield) | maintenance cost |
| 12F | Optional | Asset Fields: Liquidity Restrictions | Illiquid |
| | (pick 1 of 3) | (Illiquid/RestrictedTime/LiquidityHaircut) | |
| 12G | Optional | Asset Fields: Liquidation Priority LPn (LPn | LP2 |
| | | means allowed to liquidate only for funding of | |
| | | goals of priority Pn or higher) | |

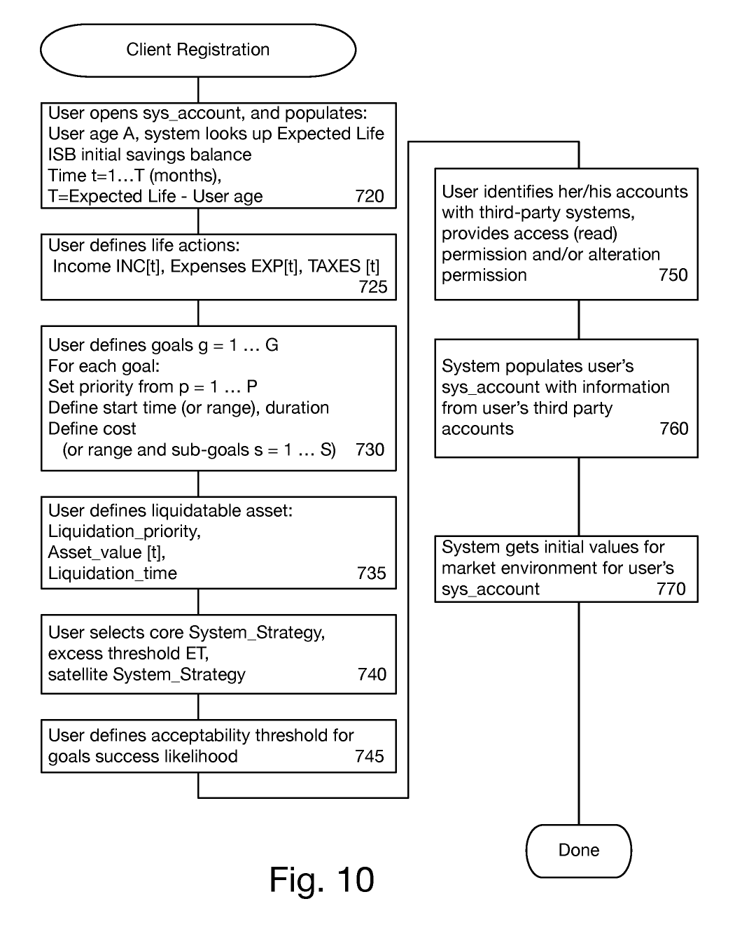

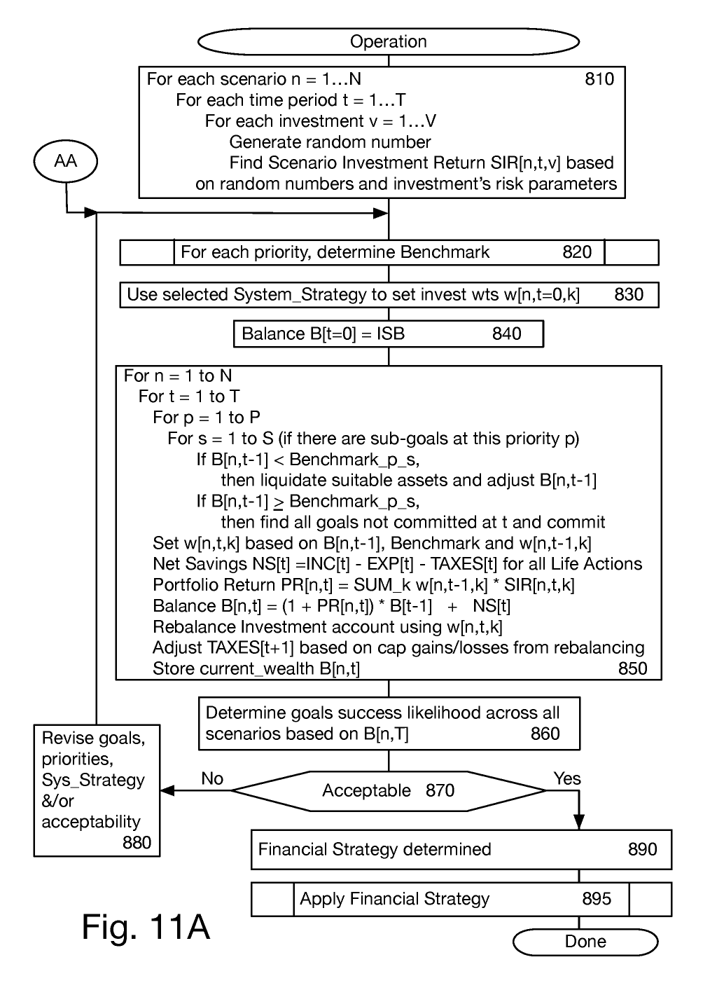

FIG. 10 is a flowchart showing client registration in a financial planning system according to the present invention. The person performing the steps is referred to as the user, and can be the financial planner or the client herself. The information created during client registration is stored in a suitable storage, such as client storages 540, 555, 575, 595 shown in FIG. 5.

At step 720, the user creates an account for herself and populates it with user descriptive information, including the user's present age, initial savings balance ISB (which can be negative if the user has outstanding loans such as student loans and/or a home mortgage). In this embodiment, the financial planning system then looks up the user's expected life from a stored table, and enables the user to adjust her expected life. The financial plan will be for a duration of T months, with T=12*(Expected Life (years)−Current Age (years)).

At step 725, the user specifies her life actions resulting in income, expenses or taxes for the duration of the financial plan, using the life action templates defined at step 715. Life actions are things that the user has already committed to, such as repaying the user's student loans.

At step 730, the user defines her goals using the goal templates defined at step 715. Goals are things that the user would like to commit to if affordable.

At step 735, the user defines her liquidatable assets, using the life action templates defined at step 715. For instance, the user may already own a home, and be willing to liquidate this upon retirement. In some embodiments, steps 725 and 735 are combined.

At step 740, the user selects her core System_Strategy from the strategies defined at step 710, defines her excess threshold ET, and selects her satellite System_Strategy from the stragies defined at step 710. The system uses the core System_Strategy until the user's excess wealth exceeds the excess threshold, at which point the system switches to the satellite System_Strategy. The default is to use the core System_Strategy for wealth up to the excess threshold, and then use the satellite System_Strategy for wealth exceeding the excess threshold; however, in some embodiments, the user may specify that the satellite System_Strategy is used for all wealth.

In some embodiments, the user specifies a first core System_Strategy, and then after ET is reached, specifies a second core System_Strategy in lieu of the first for wealth up to ET, and then a third System_Strategy for wealth exceeding ET. For example, the user may select a first medium risk strategy as her core System_Strategy, such as an equity index investment, and then after excess wealth exceeds ET, switch to a low risk strategy as her core System_Strategy for her wealth up to ET, such as a government bond fund, and a high risk strategy for excess wealth exceeding ET, such as a foreign country small cap equities investment.

In some embodiments, the user can specify multiple excess thresholds ET_1, ET_2, ET_3, . . . with respective System_Strategies.

In some embodiments, the financial planning system suggests System_Strategies based on the value of the excess threshold. For instance, for an excess wealth threshold of $3 million, the system might suggest a bitcoin investment, or for an excess wealth threshold of $10 million, the system might suggest original artwork or other investment having a relatively unpredictable return.

At step 745, the user defines her scenario acceptability threshold. This pre-defined acceptability enables the financial planning system to automatically decide whether a financial plan is acceptable, whereas conventional financial planning systems leave that decision to the user, expecting the user to iterate for awhile. For example, the user may define acceptability as Acceptability=[p1 80%, p2 60%, p3 40%] meaning a financial plan is acceptable if it has at least an 80% chance of achieving priority 1 goals and at least a 60% chance of achieving priority 2 goals and at least a 40% chance of achieving priority 3 goals.

If the user is concerned with having all of her goals met, then goals success likelihood is defined as at step 280 of FIG. 3D and acceptability is the minimum chance of achieving all of her goals that the user is comfortable with, such as 0.85, that is, an 85% chance that she will achieve all of her goals. Alternatively, the user can specify that goals of up to a particular priority level pAccept must be met for acceptability, so that goal success likelihood considers only those priority levels, while goals at less important priority levels are ignored for acceptability:

Goals_success_likelihood=N⁻¹*Σₙ₌₁^{N}1(B[n,T]>Benchmark_{pAccept}) (equation 15)

In other embodiments, other techniques for defining acceptability are used.

At step 750, the user identifies the client's accounts with third-party systems, such as banks or brokerages, and provides access (read) and/or alteration permission.

At step 760, the financial planning system populates the client's account with information from the client's third-party accounts.

At step 770, the financial planning system gets initial values for the market environment for the client's account.

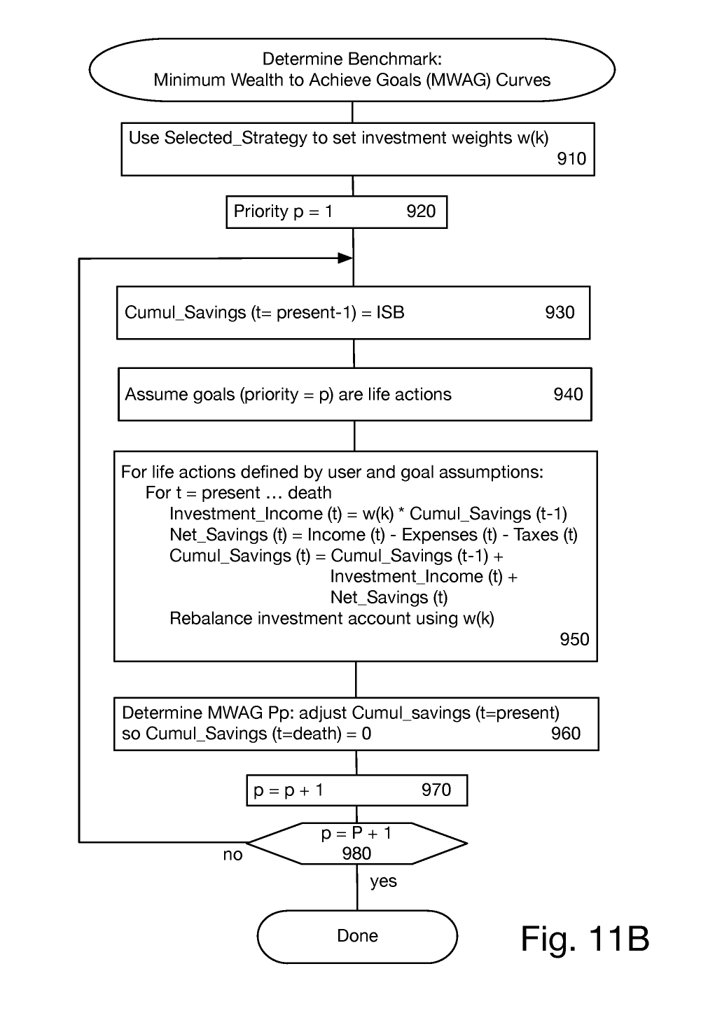

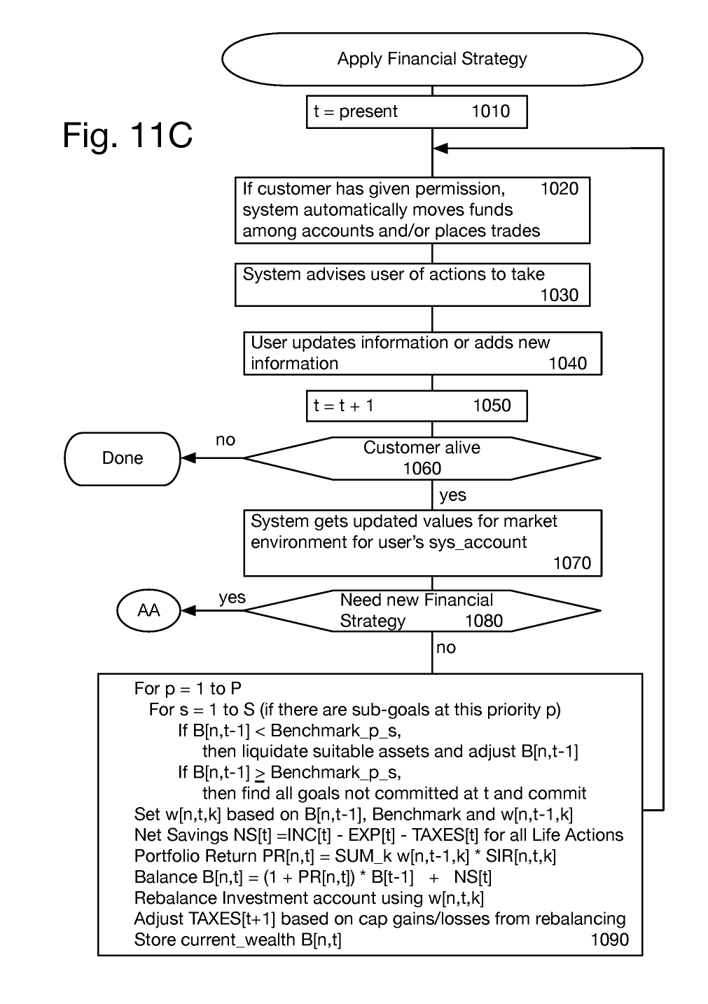

FIGS. 11A-11C are a flowchart showing operation in a financial planning system according to the present invention. One embodiment is shown; other embodiments are contemplated. The information created during operation is stored in a suitable storage, such as client storages 540, 555, 575, 595, shown in FIG. 5.

Step 810 is similar to step 255 of FIG. 3D. Typically, about N=1,000 Monte Carlo simulations are performed, but any number may be used as long as it is large enough so that the statistical distribution across scenarios is realistic.

At step 820, for each priority level, the benchmark curves are determined. In one embodiment, MWAG curves based on hypothetical wealth, discussed with respect to FIGS. 8A-8H, are used as the benchmark curves.

FIG. 11B is a flowchart showing generation of MWAG curves as the benchmark curves.

At step 910, the investment weights w(k) are selected. The investment weights do not vary with time, and the rate of return of each investment also does not vary with time. Typically, the core System_Strategy from step 740 is used as the Selected_Strategy for determining w(k), with the fixed return for each investment being the most conservative expected return.

At step 920, the current priority level is set to “1”.

At step 930, Cumulative_Savings is initialized to the ISB from step 720.

At step 940, all of the goals at the current priority level are converted to life actions. If the goal has a time range, the latest start date is used. If the goal has a value range, it is split into sub-goals, so that a MWAG curve will be generated for each sub-goal.

At step 950, the user's wealth (Cumulative_Savings) is calculated for each period of the financial plan, thereby generating a Wealth curve for the current priority level.

At step 960, the financial planning system determines the MWAG curve corresponding to the Wealth curve for the current priority level.

At step 970, the current priority level is incremented by one.

At step 980, the financial planning system checks whether the current priority level exceeds the maximum priority level P defined at step 730. If not, processing returns to step 930. If so, processing is complete, that is, the benchmark curves have been determined.

Returning to FIG. 11A, at step 830, the System_Strategy y(i), typically the core System_Strategy selected at step 740, specifies the initial investment weights. The strategy enables the user to change her investment allocation over the duration of the financial plan. In contrast, a conventional financial plan uses the same investment allocation for the duration of the financial plan, as shown at step 260 of FIG. 3D.

At step 840, the financial planning system sets the initial account balance B[t=0] to be the ISB defined at step 720.

At step 850, the financial planning system creates the N scenarios based on the selected system investment strategy, the benchmark curves, the user's goals and life actions, and the Scenario Investment Return SIR[n,t,v] from the Monte Carlo simulations.

For each scenario n, for each time period t, for each priority level p, and for each subgoal s (if any goal has value variability represented as sub-goals):
The financial planning system first determines whether the user's current savings balance B[n,t−1] is less than the benchmark curve for this priority level, that is, whether the user cannot afford all goals at this priority. If so, the system determines whether asset liquidation is available at this priority level, at this time, and would result in the user's current savings balance exceeding the benchmark curve; any such assets are “suitable assets” and are automatically liquidated by the system. The fact of asset liquidation, and the date it occurs, form part of the financial plan. Conventional financial planning systems are unable to automatically decide when and whether to liquidate assets.
Next, the financial planning system determines whether the user's current savings balance B[n,t−1], with any adjustments from asset liquidation, is at least equal to the benchmark curve for this priority level, that is, whether the user can afford any goals at this priority. If so, the system converts such goals to life actions, sometimes referred to as “commits” such goal. The fact of goal commitment, the date it occurs, and the value of the goal (if the goal was specified with a value range) form part of the financial plan. Conventional financial planning systems are unable to automatically decide when and whether to commit to goals, as such systems assume all goals are required. The present financial planning system is far more efficient from a user's viewpoint than conventional financial planning systems because it obeys the user's goal preferences, expressed as goal priorities, in automatically deciding which goals are achievable based on the user's situation.
Next, the investment weights w[n,t,k] for this period are automatically determined based on the current savings balance B[n,t−1], the benchmark curve, and the weights for the selected strategy y(i) at this time. The core System_Strategy provides the investment weights until the user's “excess wealth”, defined as (B[n,t−1]−Benchmark) exceeds the excess threshold ET defined at step 740, at which point the satellite System_Strategy provides the investment weights. For instance, when minimum wealth to achieve goals is used as the benchmark, then the value of the curve for the least important priority goal is subtracted from the current wealth to yield the excess wealth. When the excess wealth exceeds the excess threshold ET, the System_Strategy changes to the satellite System_Strategy.
Then the financial planning system system computes the Net Savings NS[t] for all life actions:

NS[t]=INC[t]−EXP[t]−TAXES[t] (equation 16)

where

INC[t]=Σₖ₌₁^{K}LA_INC[k,t,n] (equation 17)

EXP[t]=Σₖ₌₁^{K}LA_EXP[k,t,n] (equation 18)

TAXES[t]=Σₖ₌₁^{K}LA_TAX[k,t,n] (equation 19)
Then the financial planning system computes the scenario's Portfolio Return PR[n,t], similar to step 275 of FIG. 3D:

PR[n,t]=Σₖ₌₁^{K}SIR[n,t,k]*wI[k] (equation 20)

and computes the account balance B[n,t] similar to step 275 of FIG. 3D:

B[n,t]=(1+PR[n,t])*B[n,t−1]+NS[t] (equation 21)
The financial planning system rebalances the goal account investments to conform to the weighted allocation in the selected System_Strategy. It will be recalled that since different investments may experience different growth, the portfolio needs to be rebalanced.
The financial planning system determines whether rebalancing would result in any trades that incurred capital gains or losses, and if so, adjusts the user's tax liability for the next period t+1 accordingly. Conventional financial planning system do not do this.
At the conclusion of the scenario, the financial planning system stores the account balance B[n,t=T], also referred to as the wealth or the cumulative savings.

At step 860, the financial planning system determines the goals success likelihood across all scenarios. As used herein and in the claims, for a goal to be successful, the financial planning system must commit that goal, and successfully fund that goal. Successful funding generally corresponds to the user's wealth remaining above the MWAG curve for the duration of the goal.

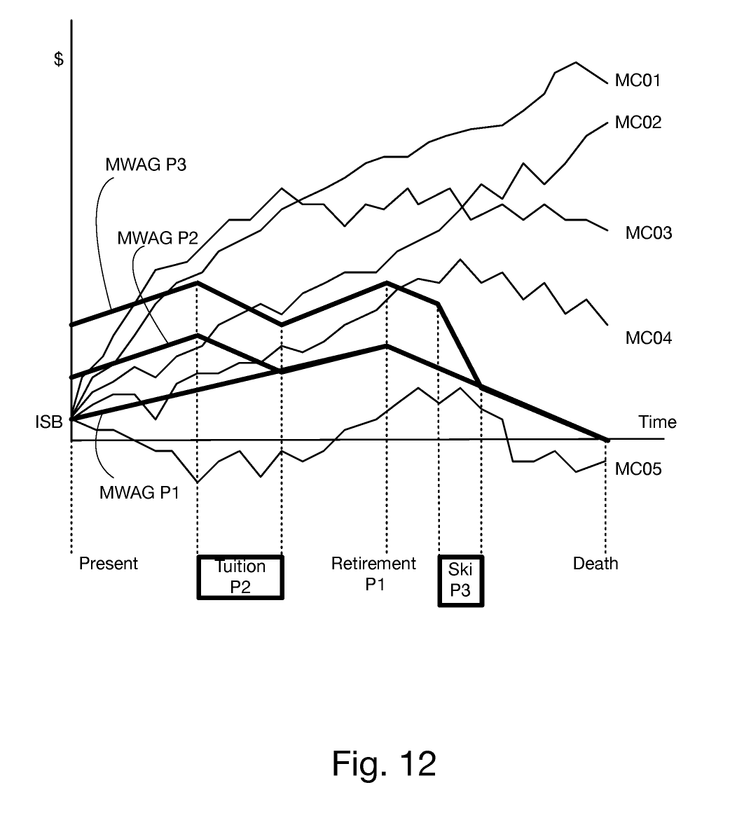

An example of determining goals success likelihood will now be discussed with reference to FIG. 12, showing five wealth simulation scenarios MC01 . . . MC05, with Monte Carlo simulations used to determine investment performance, along with the MWAG curves of FIG. 8H.

The sole priority 1 goal in this example is retirement, corresponding to the MWAG P1 curve. At the start of the retirement goal, indicated as a vertical dashed line, four of the five simulation scenarios are above the MWAG P1 curve, so the probability that the retirement goal will be achieved is ⅘=80%.

The sole priority 2 goal in this example is tuition, corresponding to the MWAG P2 curve. At the start of the tuition goal, indicated as a vertical dashed line, two of the five simulation scenarios are above the MWAG P2 curve, so the probability that the tuition goal will be achieved is ⅖=40%.

The sole priority 3 goal in this example is a ski trip, corresponding to the MWAG P3 curve. At the start of the ski trip goal, indicated as a vertical dashed line, four of the five simulation scenarios are above the MWAG P3 curve, so the probability that the ski trip goal will be achieved is ⅘=80%.

Generally, it is desirable that priority 2 goals have a higher success likelihood than priority 3 goals. However, in the scenario of FIG. 12, the priority 3 goal was more successful due to timing: it occurred much later in the user's life than the priority 2 goal, by which time the user was able to save enough for the priority 3 goal.

At step 870, the financial planning system decides whether the Financial Plan is acceptable in accordance with step 745. If so, processing continues at step 890. For example, if the user's acceptability threshold is Acceptability=[p1 80%, p2 60%, p3 40%], then the example of FIG. 12, wherein goals success=[p1 80%, p2 40%, p3 80%] is unacceptable because the p2 goal likelihood is 40% but the p2 acceptability threshold is 60%.

If the Financial Plan is not acceptable, at step 880, the user revises goals and/or priorities and/or investment allocation strategies and/or acceptability threshold and processing returns to step 820. At step 880, the financial planning system may suggest strategies or investments to the user, with the suggestions based on the user's wealth and goals. Exemplary suggestions made by the financial planning system may be:
asset liquidation beyond what the user has deemed acceptable liquidation priority when defining the asset;
obtaining a loan to fund the user's goals; and/or
choose a riskier core System_Strategy in the hope of higher returns; and/or
adjust acceptability threshold.
   As a further example, in one embodiment, a unique “inherent priority level” field is added to each goal template defined by the financial planner, see Table 1 field 2A; and at step 880, the financial planning system suggests altering the priority of the goal in accordance with its inherent priority level.

At step 890, the financial planning system defines the user's Financial Strategy as the parameters leading to goals success likelihood deemed acceptable at step 870. These parameters include the initial savings balance specified at step 720, the life actions specified at step 725, the goals and priority levels specified at step 730, the liquidatable assets specified at step 735, the System_Strategies specified at step 740, the acceptability threshold specified at step 745, and the benchmark curves determined at step 820.

Conventional financial planning systems produce a financial plan, possibly misleading the user into false certainty regarding goal achievement. In contrast, the present financial planning system produces a financial strategy with success likelihoods for the goals, more accurately representing future uncertainty to the user.

At step 895, the financial planning system implements or applies the Financial Strategy deemed acceptable at step 870, as shown in FIG. 11C.

Turning to FIG. 11C, at step 1010, the financial planning system synchronizes the present time with the time t=1 of the Financial Strategy deemed acceptable at step 870.

At step 1020, if the customer, also referred to as the user or the client, has given permission, the financial planning system automatically moves funds among accounts, and/or places trades in accordance with the Financial Strategy. Fund movement occurs when the ISB is allocated among accounts, when the monthly savings is allocated among accounts, and when accounts are rebalanced to conform to the financial plan.

At step 1030, for those actions specified by the Financial Strategy that cannot be automatically accomplished, the financial planning system notifies the customer of what actions to take. For instance, if an asset such as a painting is to be liquidated, the customer is notified.

At step 1040, the user optionally updates information or adds new information. Examples of updating information are: changing the parameters of life actions or goals, or deleting life actions or goals. Examples of adding new information are: adding new life actions, adding new goals or financial accounts.

At step 1050, the financial planning system determines that sufficient time has elapsed so that the next period t+1 of the Financial Strategy has arrived. Typically, at step 720, the financial period is defined as a month, but in some cases it may be a week, a bi-week, a quarter-year, a year or other suitable timeframe.

At step 1060, the financial planning system checks whether the user is still alive, or whether another condition at the end of the Financial Strategy has occurred. If so, processing is complete. If not, processing continues to step 1070.

At step 1070, similar to step 770, the financial planning system gets current values for the market environment for the client's account.

At step 1080, the financial planning system determines whether a new financial strategy is needed. Generally, a new financial strategy is needed when at least one of the following events has occurred, as specified by the user, indicating a change to wealth over time:
changes in life actions,
changes in goals,
changes in System_Strategy,
changes in acceptability threshold,
new user account information, particularly a new type of account such as a 401(k) account.
   If none of the above events has occurred, that is, no events or only events indicating a change to the status of the wealth, such as updating the current wealth or the liquidation value of a life action, then a new financial strategy is not needed, and processing continues at step 1090. If a new financial strategy is needed, processing returns to step 820 in FIG. 11A, except with the initial savings balance reset to the current wealth, that is, ISB=B[t].

At step 1090, only the period t+1 of the existing Financial Strategy is computed, reflecting the current market environment from step 1070 and any changes to current position made by the user at step 1040. Processing at step 1090 is similar to processing at step 850, but for only n=reality (instead of one of N simulation scenarios) and only t=t+1 (instead of t=1 to T), and will not be discussed in detail for brevity. Step 1090 comprises implementing the acceptable financial strategy by determining actions period-by-period. Then, processing continues at step 1020.

An advantage of the present financial planning system is that if there have been no material changes in the user's circumstances since the last period, only the current period needs to be computed at step 1090; in contrast, a conventional financial planning system gives only a plan for one period, and needs to be completely re-run at a next period. The present financial planning system needs to be completely re-run only in a period where there have been material changes in the user's circumstances (the “yes” branch from step 1080 to step 820, indicated by AA in a circle).

Although an illustrative embodiment of the present invention, and various modifications thereof, have been described in detail herein with reference to the accompanying drawings, it is to be understood that the invention is not limited to this precise embodiment and the described modifications, and that various changes and further modifications may be effected therein by one skilled in the art without departing from the scope or spirit of the invention as defined in the appended claims.

What is claimed is:

1. A method of financial planning for a user comprising:
receiving, from the user: life actions, goals, an investment strategy, and an acceptability threshold;
generating a benchmark based on the life actions and the goals;
determining wealth based on the investment strategy and the life actions;
converting goals to life actions when the determined wealth exceeds the benchmark; and
deciding a financial strategy is acceptable when goal success likelihood exceeds the acceptability threshold, the goal success likelihood being the probability that the respective goals were converted to life actions;
wherein the financial strategy comprises the life actions, the goals, the investment strategy, the acceptability threshold and the benchmark.

2. The method of claim 1, wherein each of the goals has a priority, and wherein converting goals to life actions is also based on the priority of the goals.

3. The method of claim 2, wherein at least one of the life actions has a liquidation priority, and wherein converting goals to life actions includes determining whether any of the life actions should be liquidated based on the liquidation priority of the life actions and the priority of the goals.

4. The method of claim 2, wherein the acceptability threshold includes an acceptability value for each priority.

5. The method of claim 2, wherein the benchmark includes a priority benchmark for each priority.

6. The method of claim 1, wherein the goals have respective start dates, and the converting occurs on the respective start dates.

7. The method of claim 6, wherein the start date of a goal is within a range, the generating assumes the latest date in the range, and the converting occurs within the range.

8. The method of claim 1, wherein at least one of the goals has a variable cost, and further comprising dividing the variable cost goal into sub-goals having fixed costs.

9. The method of claim 1, wherein the investment strategy includes a core strategy for wealth up to an excess wealth threshold, and a satellite strategy for wealth exceeding the excess wealth threshold.

10. The method of claim 1, wherein receiving includes receiving information relating to how many temporal periods the financial strategy should encompass, and wherein determining occurs for each of the temporal periods.

11. The method of claim 10, further comprising producing a set of simulations for investment strategies for each of the temporal periods, and wherein the determining and converting occurs for each of the simulations, and wherein the deciding is based on all of the simulations.

12. The method of claim 10, wherein determining includes adjusting taxes for a next temporal period based on rebalancing, during a current temporal period, wealth in accordance with the investment strategy.

13. The method of claim 1, wherein the benchmark is minimum wealth to achieve goals obtained by
adjusting hypothetical wealth at the start of a planning period so that the hypothetical wealth at the end of the planning period is zero.

14. The method of claim 13, wherein the hypothetical wealth is based on a fixed rate of return.

15. The method of claim 13, wherein the planning period comprises temporal periods, and the hypothetical wealth is based on an average rate of return for each temporal period obtained from simulations.

16. The method of claim 1, further comprising, when the goal success likelihood is less than the acceptability threshold, revising at least one of the goals, the investment strategy and the acceptability threshold, and repeating the generating, determining, converting and deciding.

17. The method of claim 1, wherein receiving includes user account information, and further comprising moving funds among accounts specified in the user account information in accordance with the acceptable financial strategy.

18. The method of claim 1, further comprising placing a trade for a portion of the wealth in accordance with the acceptable financial strategy.

19. The method of claim 1, further comprising implementing the acceptable financial strategy by determining actions period-by-period.

20. The method of claim 1, further comprising
implementing the acceptable financial strategy by obeying the acceptable financial strategy until new information received from the user indicates a new financial strategy is needed; and
repeating the generating, determining, converting and deciding based on the life actions, goals, investment strategy, and acceptability threshold received from the user, as updated by the new information received from the user.

21. A system for financial planning for a user comprising:
a communication channel for receiving, from the user: life actions, goals, an investment strategy, and an acceptability threshold;
a data storage for storing the life actions, goals, investment strategy and acceptability threshold;
a processor for
(a) generating a benchmark based on the life actions and the goals;
(b) determining wealth based on the investment strategy and the life actions;
(c) converting goals to life actions when the determined wealth exceeds the benchmark; and
(d) deciding a financial strategy is acceptable when goal success likelihood exceeds the acceptability threshold, the goal success likelihood being the probability that the respective goals were converted to life actions;
wherein the financial strategy comprises the life actions, the goals, the investment strategy, the acceptability threshold and the benchmark, and
the data storage is also for storing the benchmark and the acceptable financial strategy.

22. The system of claim 21, wherein each of the goals has a priority, and wherein converting goals to life actions is also based on the priority of the goals.

23. The system of claim 22, wherein at least one of the life actions has a liquidation priority, and wherein converting goals to life actions includes determining whether any of the life actions should be liquidated based on the liquidation priority of the life actions and the priority of the goals.

24. The system of claim 22, wherein the acceptability threshold includes an acceptability value for each priority.

25. The system of claim 22, wherein the benchmark includes a priority benchmark for each priority.

26. The system of claim 21, wherein the goals have respective start dates, and the converting occurs on the respective start dates.

27. The system of claim 26, wherein the start date of a goal is within a range, the generating assumes the latest date in the range, and the converting occurs within the range.

28. The system of claim 21, wherein at least one of the goals has a variable cost, and further comprising dividing the variable cost goal into sub-goals having fixed costs.

29. The system of claim 21, wherein the investment strategy includes a core strategy for wealth up to an excess wealth threshold, and a satellite strategy for wealth exceeding the excess wealth threshold.

30. The system of claim 21, wherein receiving includes receiving information relating to how many temporal periods the financial strategy should encompass, and wherein determining occurs for each of the temporal periods.

31. The system of claim 30, further comprising producing a set of simulations for investment strategies for each of the temporal periods, and wherein the determining and converting occurs for each of the simulations, and wherein the deciding is based on all of the simulations.

32. The system of claim 30, wherein determining includes adjusting taxes for a next temporal period based on rebalancing, during a current temporal period, wealth in accordance with the investment strategy.

33. The system of claim 21, wherein the benchmark is minimum wealth to achieve goals obtained by
adjusting hypothetical wealth at the start of a planning period so that the hypothetical wealth at the end of the planning period is zero.

34. The system of claim 33, wherein the hypothetical wealth is based on a fixed rate of return.

35. The system of claim 33, wherein the planning period comprises temporal periods, and the hypothetical wealth is based on an average rate of return for each temporal period obtained from simulations.

36. The system of claim 21, further comprising, when the goal success likelihood is less than the acceptability threshold, revising at least one of the goals, the investment strategy and the acceptability threshold, and repeating the generating, determining, converting and deciding.

37. The system of claim 21, wherein receiving includes user account information, and further comprising moving funds among accounts specified in the user account information in accordance with the acceptable financial strategy.

38. The system of claim 21, further comprising placing a trade for a portion of the wealth in accordance with the acceptable financial strategy.

39. The system of claim 21, further comprising implementing the acceptable financial strategy by determining actions period-by-period.

40. The system of claim 21, further comprising
implementing the acceptable financial strategy by obeying the acceptable financial strategy until new information received from the user indicates a new financial strategy is needed; and
repeating the generating, determining, converting and deciding based on the life actions, goals, investment strategy, and acceptability threshold received from the user, as updated by the new information received from the user.
